(19) United States
(12) Patent Application Publication
(10) Pub. No.: US 2020/0201808 A1
(43) Pub. Date: Jun. 25, 2020

(54) TIME-DIVISION MULTIPLEXING (TDM) DATA TRANSFER ON SERIAL INTERFACES

(71) Applicant: QUALCOMM Incorporated, San Diego, CA (US)

(72) Inventors: Sharon GRAIF, Zichron Yakov (IL); Lior AMARILIO, Yokneam (IL); Radu PITIGOI-ARON, San Jose, CA (US)

(21) Appl. No.: 16/592,367

(22) Filed: Oct. 3, 2019

Related U.S. Application Data
(60) Provisional application No. 62/783,770, filed on Dec. 21, 2018.

(51) Int. Cl. G06F 13/42

(52) U.S. Cl. CPC G06F 13/4282; G06F 2213/0016

(57) ABSTRACT

Systems, methods, and apparatus for serial bus arbitration are described. A method for managing transactions executed on a serial bus includes configuring a slave device with information identifying a first timeslot in a first transaction type that is conducted repetitively in accordance with a repetitive time period (RTP) schedule, initiating a first transaction of the first transaction type at a first point in time that is defined by the RTP schedule, and exchanging first data with the slave device during the first timeslot in the first transaction. The serial bus may be operated in accordance with an asynchronous protocol. In one example, the asynchronous protocol is an I3C protocol.

### PRIORITY

This application claims priority to and the benefit of U.S. Provisional Patent Application Ser. No. 62/783,770 filed in the U.S. Patent Office on Dec. 21, 2018, the entire content of this application being incorporated herein by reference as if fully set forth below in its entirety and for all applicable purposes.

### TECHNICAL FIELD

The present disclosure relates generally to an interface between processing circuits and peripheral devices and, more particularly, to providing time-division multiplexing on a serial bus.

### BACKGROUND

Mobile communication devices may include a variety of components including circuit boards, integrated circuit (IC) devices and/or System-on-Chip (SoC) devices. The components may include processing circuits, user interface components, storage and other peripheral components that communicate through a serial bus. The serial bus may be operated in accordance with a standardized or proprietary protocol. In one example, a serial bus operated in accordance with Inter-Integrated Circuit (I2C bus or I²C) protocols. The I2C bus architecture was developed to connect low-speed peripherals to a processor, and the I2C bus can operate as a multi-drop bus. A two-wire I2C bus includes a Serial Data Line (SDA) that carries a data signal, and a Serial Clock Line (SCL) that carries a clock signal.

A serial bus may employ a multi-master protocol in which one or more devices can serve as a master and a slave for different messages transmitted on the serial bus. In one example, Improved Inter-Integrated Circuit (I3C) protocols may be used to control operations on a serial bus. I3C protocols are defined by the Mobile Industry Processor Interface (MIPI) Alliance and derive certain implementation aspects from the I2C protocol. Original implementations of the I2C protocol supported data signaling rates of up to 100 kilobits per second (100 kbps) in standard-mode operation, with more recent standards supporting speeds of 400 kbps in fast-mode operation, and 1 megabit per second (Mbps) in fast-mode plus operation.

In another example, the Radio Frequency Front-End (RFFE) interface defined by the MIPI Alliance provides a communication interface for controlling various radio frequency (RF) front-end devices, including power amplifier (PA), low-noise amplifiers (LNAs), antenna tuners, filters, sensors, power management devices, switches, etc. These devices may be collocated in a single IC device or provided in multiple IC devices. In a mobile communication device, multiple antennas and radio transceivers may support multiple concurrent RF links.

In another example, the system power management interface (SPMI) defined by the MIPI Alliance provides a hardware interface that may be implemented between baseband or application processors and peripheral components. In some implementations, the SPMI is deployed to support power management operations within a device.

As applications have become more complex, there is a continually increasing demand for improved bus management techniques that can reduce bus latency.

### SUMMARY

Certain aspects of the disclosure relate to systems, apparatus, methods and techniques that enable alerts and/or requests for bus arbitration to be sent in a first direction over a serial bus while a datagram is being transmitted in a second direction over the serial bus.

In various aspects of the disclosure, a method for managing transactions executed on a serial bus includes configuring a slave device with information identifying a first timeslot in a first transaction type that is conducted repetitively in accordance with a repetitive time period (RTP) schedule, initiating a first transaction of the first transaction type at a first point in time that is defined by the RTP schedule, and exchanging first data with the slave device during the first timeslot in the first transaction. The serial bus may be operated in accordance with an asynchronous protocol. In one example, the asynchronous protocol is an I3C protocol.

In certain aspects, exchanging the first data with the slave device includes receiving one or more bytes of data from the serial bus during the first timeslot in the first transaction. Exchanging the first data with the slave device may include transmitting one or more bytes of data over the serial bus during the first timeslot in the first transaction.

In some aspects, the method includes initiating a second transaction of the first transaction type in response to an in-band interrupt asserted by the slave device. Information provided by the slave device during processing of the in-band interrupt identifies the first transaction type. The second transaction may be conducted independently of the RTP schedule. In one aspect, the method includes initiating a second transaction of the first transaction type independently of the RTP schedule. In one aspect, the method includes configuring the slave device with information identifying a second timeslot in a first transaction type, and exchanging second data with the slave device during the second timeslot in the first transaction.

In certain aspects, the method includes configuring the slave device with information identifying a second timeslot in a second transaction type that is conducted repetitively in accordance with the RTP schedule, initiating a first transaction of the second transaction type at a second point in time that is defined by the RTP schedule, and exchanging one or more bytes of data with the slave device during the second timeslot in the second transaction. A first broadcast command code may be transmitted at the first point in time to initiate the first transaction of the first transaction type, and a second broadcast command code may be transmitted at the second point in time to initiate the first transaction of the second transaction type. The periodicity of transactions of the first transaction type may be the same or different from the periodicity of transactions of the second transaction type. In one aspect, the method includes broadcasting a stop command identifying the first transaction type, where the stop command cancels one or more scheduled transmissions of the first transaction type.

In various aspects of the disclosure, an apparatus includes a bus interface configured to couple the apparatus to a serial bus having a first line configured to carry a clock signal and a second line configured to carry a first data signal, and a processor. The processor may be configured to configure a slave device with information identifying a first timeslot in a first transaction type that is conducted repetitively in accordance with a RTP schedule, initiate a first transaction of the first transaction type at a first point in time that is defined by the RTP schedule, and exchange first data with the slave device during the first timeslot in the first transaction. The serial bus may be operated in accordance with an asynchronous protocol.

In various aspects of the disclosure, a computer-readable medium stores code, instructions and/or data, including code which, when executed by a processor, causes the processor to configure a slave device with information identifying a first timeslot in a first transaction type that is conducted repetitively in accordance with a RTP schedule, initiate a first transaction of the first transaction type at a first point in time that is defined by the RTP schedule, and exchange first data with the slave device during the first timeslot in the first transaction. The serial bus may be operated in accordance with an asynchronous protocol.

### BRIEF DESCRIPTION OF THE DRAWINGS

FIG. 1 illustrates an apparatus employing a data link between IC devices that is selectively operated according to one of plurality of available standards.

FIG. 2 illustrates a communication interface in which a plurality of devices is connected using a serial bus.

FIG. 3 illustrates certain aspects of an apparatus that includes multiple devices connected to a serial bus.

FIG. 4 illustrates certain aspects of the timing relationship between SDA and SCL wires on a conventional I2C bus.

FIG. 5 is a timing diagram that illustrates timing associated with multiple frames transmitted on an I2C bus.

FIG. 6 illustrates timing related to a command word sent to a slave device in accordance with I2C protocols.

FIG. 7 includes a timing diagram that illustrates an example of signaling on a serial bus when the serial bus is operated in a mode of operation defined by I3C specifications.

FIG. 8 is a timing diagram that illustrates an example of a transmission of a frame in an I3C single data rate mode.

FIG. 9 is a timing diagram that illustrates an example of a transmission of a frame in an I3C high data rate mode, where data is transmitted at double data rate (DDR).

FIG. 10 illustrates a non-arbitrable address header and an arbitrable address header that may be transmitted on a serial bus operated in accordance with I3C protocols.

FIG. 11 illustrates an example of timing when two RTP instances are configured and enabled in accordance with certain aspects disclosed herein.

FIG. 12 is a first example of an RTP configuration transaction in accordance with certain aspects disclosed herein.

FIG. 13 is a second example of an RTP configuration transaction in accordance with certain aspects disclosed herein.

FIG. 14 is a third example of an RTP configuration transaction in accordance with certain aspects disclosed herein.

FIG. 15 is a fourth example of an RTP configuration transaction in accordance with certain aspects disclosed herein.

FIG. 16 illustrates and example of a timing circuit in a slave device that is configured to support RTP in accordance with certain aspects disclosed herein.

FIG. 17 is a first example of an RTP RUN transaction in accordance with certain aspects disclosed herein.

FIG. 18 is a second example of an RTP RUN transaction in accordance with certain aspects disclosed herein.

FIG. 19 is a table illustrating an example of bit and byte assignments for an RTP control command implemented in an I3C interface in accordance with certain aspects disclosed herein.

FIG. 20 is a block diagram illustrating an example of an apparatus employing a processing circuit that may be adapted according to certain aspects disclosed herein.

FIG. 21 is a second flowchart illustrating certain aspects of an arbitration priority scheme for low latency applications coupled to a serial bus in accordance with certain aspects disclosed herein.

FIG. 22 illustrates a hardware implementation for an apparatus adapted that supports an arbitration priority scheme for low latency applications coupled to a serial bus in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects and features will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

Overview

Devices that include application-specific IC (ASIC) devices, SoCs and/or other IC devices often employ a shared communication interface that may include a serial bus or other data communication link to connect processors with modems and other peripherals. The serial bus may be operated in accordance with specifications and protocols defined by a standards body. In certain implementations, the serial bus is operated in accordance with protocols such as I2C and/or I3C protocols, which define timing relationships between signals transmitted over the serial bus. Certain aspects disclosed herein relate to systems, apparatus, methods and techniques that provide an arbitration scheme that can be used on a serial bus to minimize latency for high priority devices and improve overall link performance.

Certain aspects of this disclosure relate to the use of time-division multiplexing (TDM) on a serial bus that is controlled by an asynchronous protocol. The use of TDM permits devices or groups of devices to communicate at regular, fixed or agreed time intervals. In one example, a bus master may manage transactions executed on a serial bus by configuring a slave device with information identifying a first timeslot in a first transaction type that is conducted repetitively in accordance with a repetitive time period (RTP) schedule, initiating a first transaction of the first transaction type at a first point in time that is defined by the RTP schedule, and exchanging first data with the slave device during the first timeslot in the first transaction. The serial bus may be operated in accordance with an asynchronous protocol. In one example, the asynchronous protocol is an I3C protocol.

Example of an Apparatus with a Serial Data Link

According to certain aspects of this disclosure, a serial data link may be employed to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

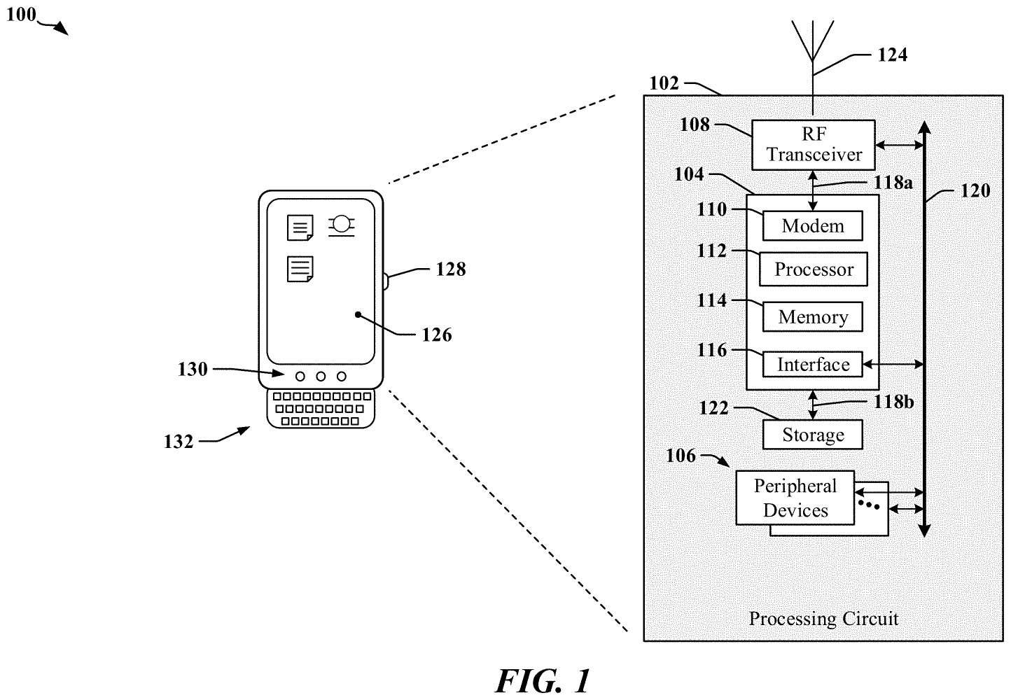

FIG. 1 illustrates an example of an apparatus 100 that employs a data communication bus. The apparatus 100 may include a processing circuit 102 having multiple circuits and/or devices 104, 106 and/or 108, which may be implemented in one or more ASICs or in an SoC for example. In one example, the apparatus 100 may be a communication device and the processing circuit 102 includes a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or in other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include non-transitory media, such as read-only memory (ROM), random-access memory (RAM), electrically erasable programmable ROM (EEPROM), flash cards, or other types memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, external keypad 132, etc. through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with standards-defined communication specifications or protocols. The processing circuit 102 may include or control a power management function that configures and manages the operation of the apparatus 100.

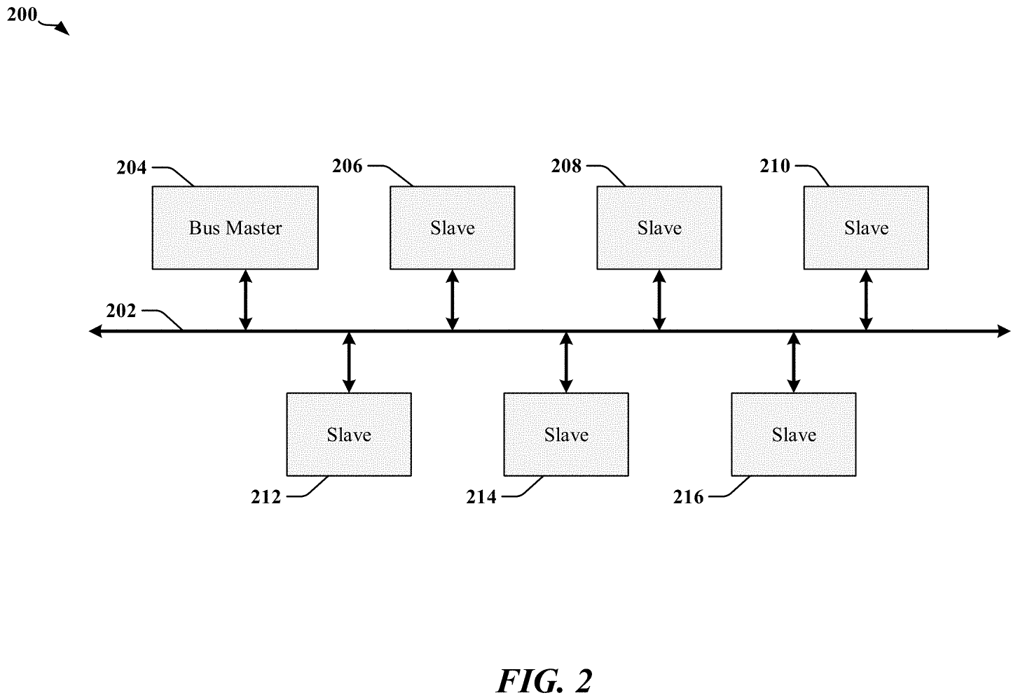

FIG. 2 illustrates a communication link 200 in which multiple devices 204, 206, 208, 210, 212, 214 and 216 are connected using a serial bus 202. In one example, the devices 204, 206, 208, 210, 212, 214 and 216 may be adapted or configured to communicate over the serial bus 202 in accordance with an I3C protocol. In some instances, one or more of the devices 204, 206, 208, 210, 212, 214 and 216 may alternatively or additionally communicate using other protocols, including an I2C protocol, for example.

Communication over the serial bus 202 may be controlled by a master device 204. In one mode of operation, the master device 204 may be configured to provide a clock signal that controls timing of a data signal. In another mode of operation, two or more of the devices 204, 206, 208, 210, 212, 214 and 216 may be configured to exchange data encoded in symbols that define signaling state of clock and data signals, where timing information is embedded in the transmission of the symbols.

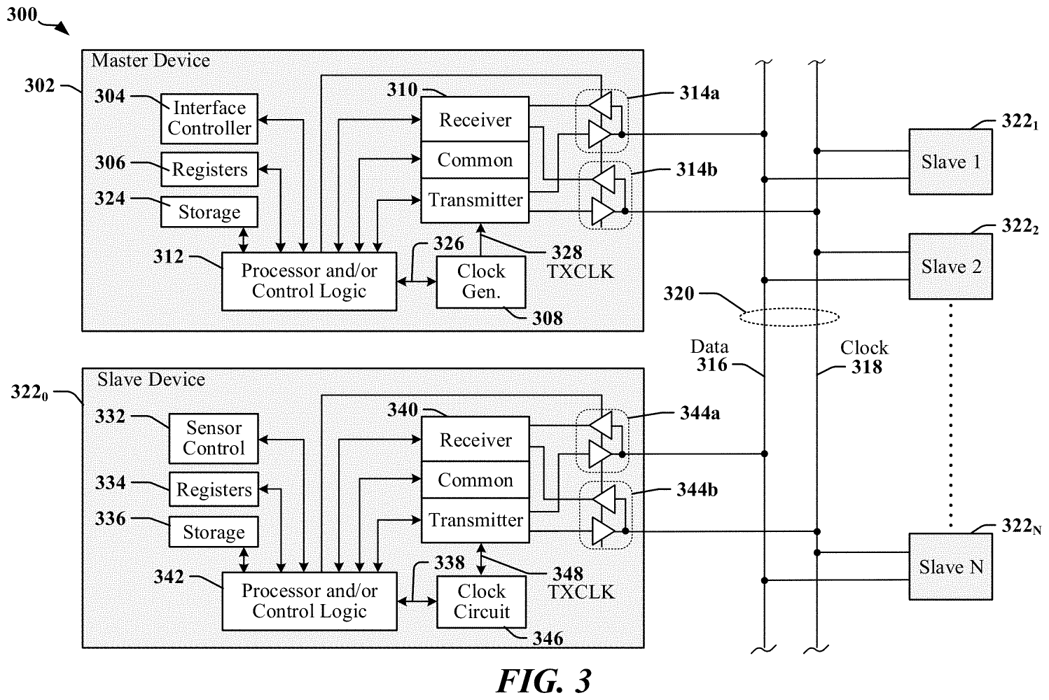

FIG. 3 illustrates certain aspects of an apparatus 300 that includes multiple devices 302, and 322₀-322_{N} coupled to a serial bus 320. The devices 302 and 322₀-322_{N} may be provided in one or more semiconductor IC devices, such as an application processor, SoC or ASIC. In various implementations, the devices 302 and 322₀-322_{N} can include, support or operate as a modem, a signal processing device, a display driver, a camera, a user interface, a sensor, a sensor controller, a media player, a transceiver, and/or other such components or devices. In some examples, one or more of the slave devices 322₀-322_{N} may be used to control, manage or monitor a sensor device. Communication between devices 302 and 322₀-322_{N} over the serial bus 320 is controlled by a bus master device 302. Certain types of bus can support multiple bus master devices 302.

In one example, a bus master device 302 may include an interface controller 304 that manages access to the serial bus, configures dynamic addresses for slave devices 322₀-322_{N} and/or generates a clock signal 328 to be transmitted on a clock line 318 of the serial bus 320. The bus master device 302 may include configuration registers 306 or other storage 324, and/or control logic 312 configured to handle protocols and/or higher-level functions. The control logic 312 may include a processing circuit such as a state machine, sequencer, signal processor or general-purpose processor. The bus master device 302 includes a transceiver 310 and line drivers/receivers 314a and 314b. The transceiver 310 may include receiver, transmitter and common circuits, where the common circuits may include timing, logic circuits and/or storage devices. In one example, the transmitter encodes and transmits data based on timing in the clock signal 328 provided by a clock generation circuit 308. Other timing clock signals 326 may be provided for the use of by the control logic 312 and other functions, circuits or modules.

At least one device 322₀-322_{N} can be configured to operate as a slave device on the serial bus 320 and may include circuits and modules that support a display, an image sensor, and/or circuits and modules that control and communicate with one or more sensors that measure environmental conditions. In one example, a slave device 322₀ configured to operate as a slave device may provide a control function, module or circuit 332 that includes circuits and modules to support a display, an image sensor, and/or circuits and modules that control and communicate with one or more sensors that measure environmental conditions. The slave device 322₀ may include configuration registers 334 or other storage 336, control logic 342, a transceiver 340 and line drivers/receivers 344a and 344b. The control logic 342 may include a processing circuit such as a state machine, sequencer, signal processor or general-purpose processor. The transceiver 310 may include receiver, transmitter and common circuits, where the common circuits may include timing, logic circuits and/or storage devices. In one example, the transmitter encodes and transmits data based on timing in a clock signal 348 provided by clock generation and/or recovery circuits 346. The clock signal 348 may be derived from a signal received from the clock line 318. Other timing clock signals 338 may be provided for the use of the control logic 342 and other functions, circuits or modules.

The serial bus 320 may be operated in accordance with an I2C, I3C, RFFE, SPMI, or other protocol. At least one device 302, 322₀-322_{N} may be configured to operate as a master device and a slave device on the serial bus 320. Two or more devices 302, 322₀-322_{N} may be configured to operate as a master device on the serial bus 320.

In some implementations, the serial bus 320 may be operated in accordance with an I3C protocol. Devices that communicate using the I3C protocol can coexist on the same serial bus 320 with devices that communicate using I2C protocols. The I3C protocols may support different communication modes, including a single data rate (SDR) mode that is compatible with I2C protocols. High-data-rate (HDR) modes may provide a data transfer rate between 6 megabits per second (Mbps) and 16 Mbps, and some HDR modes may provide higher data transfer rates. I2C protocols may conform to de facto I2C standards providing for data rates that may range between 100 kilobits per second (kbps) and 3.2 Mbps. I2C and I3C protocols may define electrical and timing aspects for signals transmitted on the 2-wire serial bus 320, in addition to data formats and aspects of bus control. In some aspects, the I2C and I3C protocols may define direct current (DC) characteristics affecting certain signal levels associated with the serial bus 320, and/or alternating current (AC) characteristics affecting certain timing aspects of signals transmitted on the serial bus 320. In some examples, a 2-wire serial bus 320 transmits data on a data line 316 and a clock signal on the clock line 318. In some instances, data may be encoded in the signaling state, or transitions in signaling state of the data line 316 and the clock line 318.

### Data Transfers Over a Serial Bus

Examples of data transfers including control signaling, command and payload transmissions are provided by way of example. The examples illustrated relate to I2C and I3C communication for convenience. However, certain concepts disclosed herein are applicable to other bus configurations and protocols, including RFFE and SPMI configurations and protocols. In one example, I3C protocols include an I3C HDR protocol that encodes data in ternary symbols (HDR-TSP), and HDR-TSP timeslots may be defined in terms of HDR-TSP words, where each slot may be expressed as a set of six successive recovered clock pulses, which is the equivalent number of clock pulses for an HDR-TSP word. In another example, I3C protocols include an I3C HDR double data rate (HDR-DDR) protocol, where timeslots may be defined in terms of HDR-DDR words and/or expressed as the number of clock pulses used to transmit an HDR-DDR word. The concepts disclose herein may be applicable to a serial bus operated in accordance with a protocol that supports multiple data lanes.

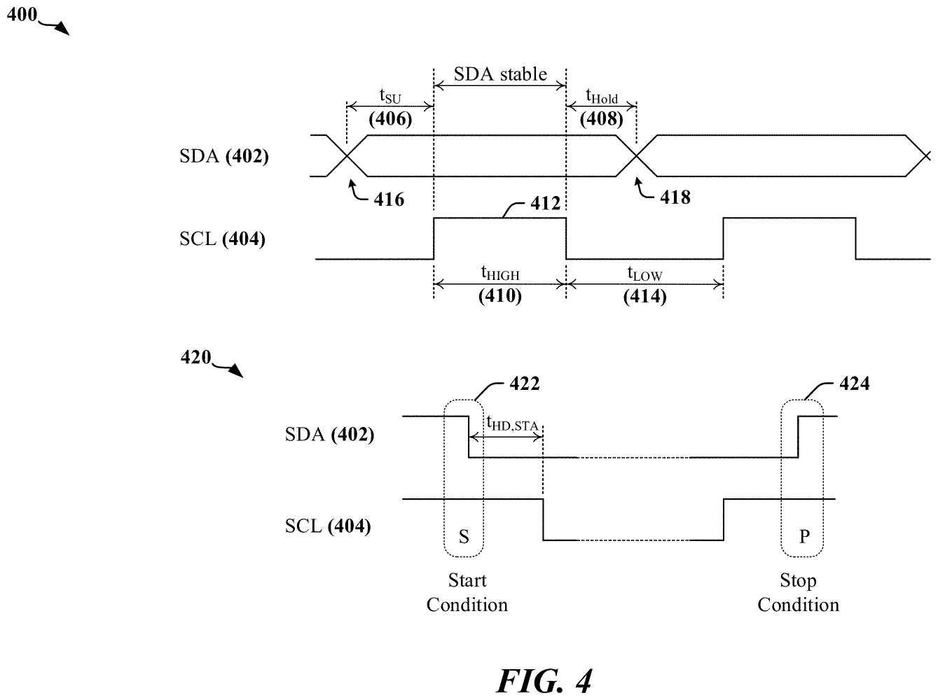

FIG. 4 includes timing diagrams 400 and 420 that illustrate the relationship between the SDA wire 402 and the SCL wire 404 of a serial bus operated in certain I2C and I3C modes. The first timing diagram 400 illustrates the timing relationship between the SDA wire 402 and the SCL wire 404 while data is being transferred on a conventionally configured I2C bus. The SCL wire 404 provides a series of pulses that can be used to sample data in the SDA wire 402. The pulses (including the pulse 412, for example) may be defined as the time during which the SCL wire 404 is determined to be in a high logic state at a receiver. When the SCL wire 404 is in the high logic state during data transmission, data on the SDA wire 402 is required to be stable and valid such that the state of the SDA wire 402 is not permitted to change when the SCL wire 404 is in the high logic state.

In one example, specifications for conventional I2C protocol implementations (which may be referred to as “I2C Specifications”) define a minimum duration 410 (t_{HIGH}) of the high period of the pulse 412 on the SCL wire 404. The I2C Specifications also define minimum durations for a setup time 406 (t_{SU}) before occurrence of the pulse 412, and a hold time 408 (t_{Hold}) after the pulse 412 terminates. The signaling state of the SDA wire 402 is expected to be stable during the setup time 406 and the hold time 408. The setup time 406 defines a maximum time period after a transition 416 between signaling states on the SDA wire 402 until the arrival of the rising edge of the pulse 412 on the SCL wire 404. The hold time 408 defines a minimum time period after the falling edge of the pulse 412 on the SCL wire 404 until a next transition 418 between signaling states on the SDA wire 402. The I2C Specifications also define a minimum duration 414 for a low period (t_{LOW}) for the SCL wire 404. The data on the SDA wire 402 is typically stable and/or can be captured for the duration 410 (t_{HIGH}) when the SCL wire 404 is in the high logic state after the leading edge of the pulse 412.

Certain protocols provide for transmission of 8-bit data (bytes) and 7-bit addresses. A receiver may acknowledge transmissions by driving the SDA wire 402 to the low logic state for one clock period. The low signaling state represents an acknowledgement (ACK) indicating successful reception and a high signaling state represents a negative acknowledgement (NACK) indicating a failure to receive or an error in reception.

The second timing diagram 420 of FIG. 4 illustrates signaling states on the SDA wire 402 and the SCL wire 404 between data transmissions on a serial bus. A start condition 422 is defined to permit the current bus master to signal that data is to be transmitted. The start condition 422 occurs when the SDA wire 402 transitions from high to low while the SCL wire 404 is high. The bus master initially transmits the start condition 422, which may be also be referred to as a start bit, followed by a 7-bit address of an I2C slave device with which it wishes to exchange data. The address is followed by a single bit that indicates whether a read or write operation is to occur. The addressed slave device, if available, responds with an ACK bit. If no slave device responds, the bus master may interpret the high logic state of the SDA wire 402 as a NACK. The master and slave devices may then exchange bytes of information in frames, in which the bytes are serialized such that the most significant bit (MSB) is transmitted first. The transmission of the byte is completed when a stop condition 424 is transmitted by the master device. The stop condition 424 occurs when the SDA wire 402 transitions from low to high while the SCL wire 404 is high.

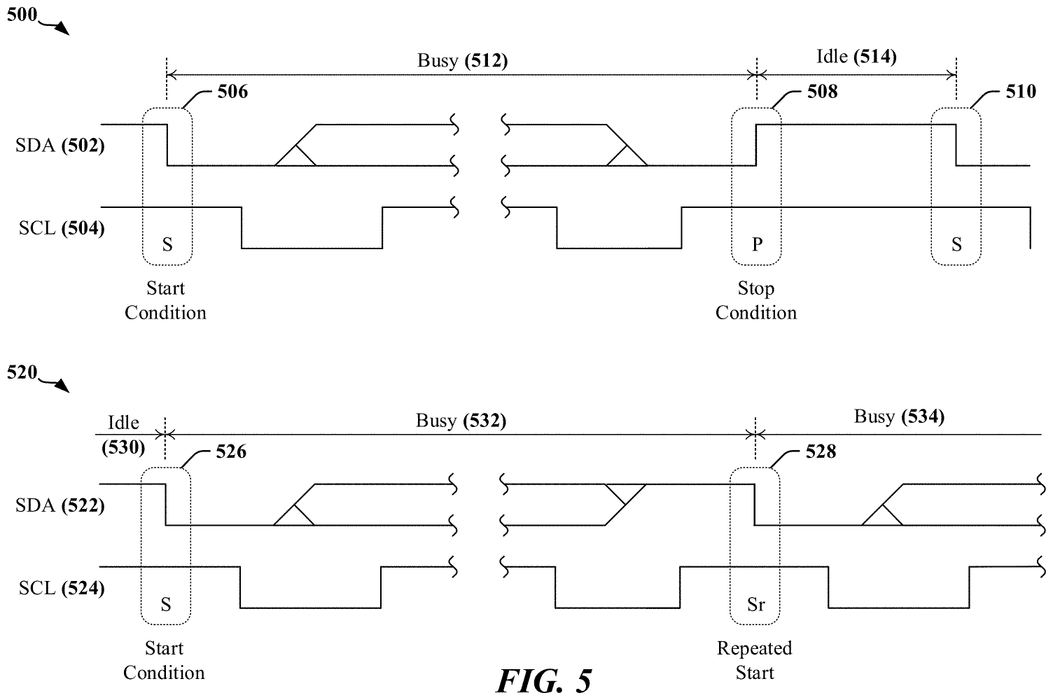

FIG. 5 includes diagrams 500 and 520 that illustrate timing associated with data transmissions on a serial bus operated in accordance with an I2C or I3C protocol. As illustrated in the first diagram 500, an idle period 514 may occur between a stop condition 508 and a consecutive start condition 510. In the illustrated example, the SDA line 502 and SCL line 504 may be held and/or driven to a high voltage state during the idle period 514. This idle period 514 may be prolonged, and may result in reduced data throughput when the serial bus remains idle between the stop condition 508 and the next start condition 510. In operation, a busy period 512 commences when the I2C bus master transmits a first start condition 506, followed by data. The busy period 512 ends when the bus master transmits a stop condition 508 and the idle period 514 ensues. The idle period 514 ends when a second start condition 510 is transmitted.

The second timing diagram 520 illustrates a method by which the number of occurrences of an idle period 514 may be reduced. In the illustrated example, data is available for transmission before a first busy period 532 ends. The bus master device may transmit a repeated start condition 528 (Sr) rather than a stop condition. The repeated start condition 528 terminates the preceding data transmission and simultaneously indicates the commencement of a next data transmission. The state transition on the SDA wire 522 corresponding to the repeated start condition 528 is identical to the state transition on the SDA wire 522 for a start condition 526 that occurs after an idle period 530. For both the start condition 526 and the repeated start condition 528, the SDA wire 522 transitions from high to low while the SCL wire 524 is high. When a repeated start condition 528 is used between data transmissions, a first busy period 532 is immediately followed by a second busy period 534.

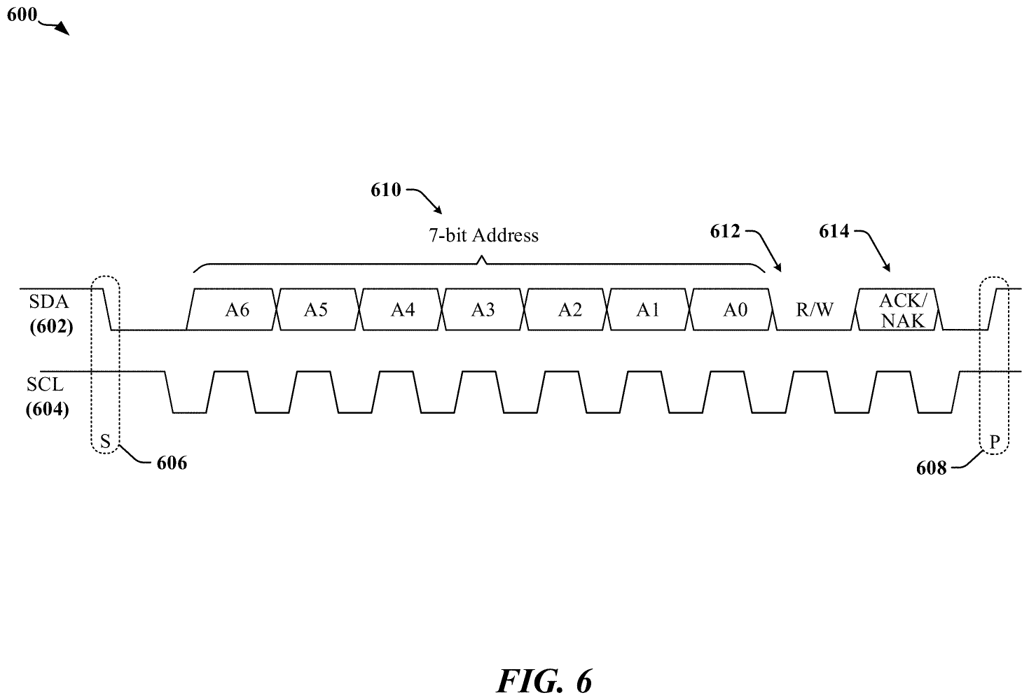

FIG. 6 illustrates an example of the timing 600 associated with an address word sent to a slave device in accordance with certain I2C and/or I3C protocols. In the example, a master device initiates the transaction with a start condition 606, whereby the SDA wire 602 is driven from high to low while the SCL wire remains high. The master device then transmits a clock signal on the SCL wire 604. The seven-bit address 610 of a slave device is then transmitted on the SDA wire 602. The seven-bit address 610 is followed by a Write/Read command bit 612, which indicates “Write” when low and “Read” when high. The slave device may respond in the next clock interval 614 with an acknowledgment (ACK) by driving the SDA wire 602 low. If the slave device does not respond, the SDA wire 602 is pulled high and the master device treats the lack of response as a NACK. The master device may terminate the transaction with a stop condition 608 by driving the SDA wire 602 from low to high while the SCL wire 604 is high. This transaction can be used to determine whether a slave device with the transmitted address coupled to the serial bus is in an active state.

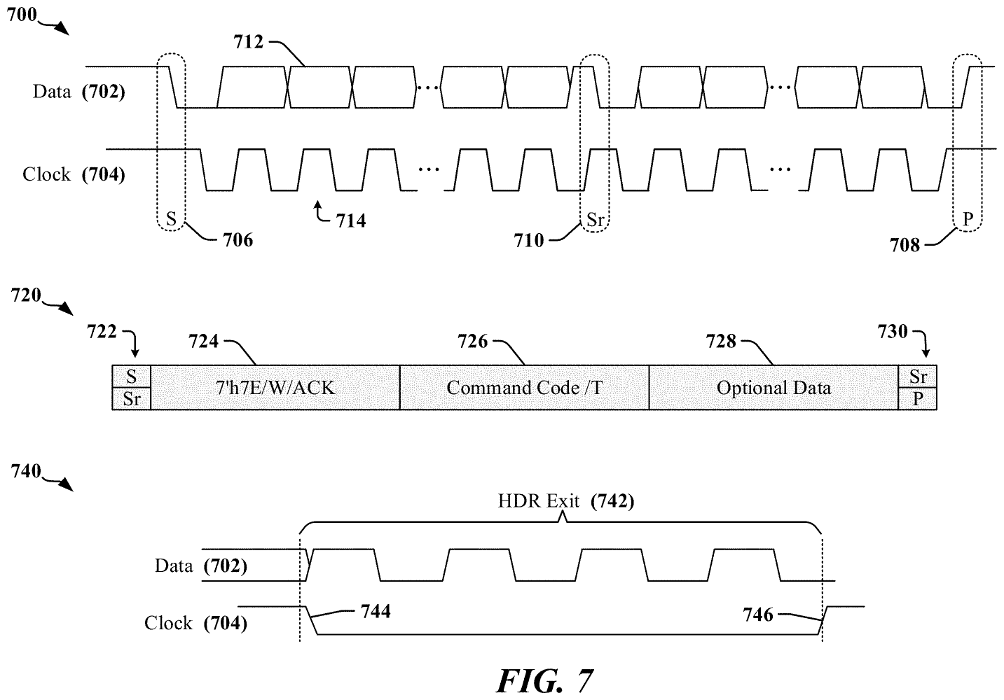

FIG. 7 illustrates signaling 700 on a serial bus when the serial bus is operated in a single data rate (SDR) mode of operation defined by I3C specifications. Data transmitted on a first wire of the serial bus, which may be referred to as the Data wire 702, SDA or SDATA, may be captured using a clock signal transmitted on a second wire of the serial bus, which may be referred to as the Clock wire 704, SCL or SCLOCK. During data transmission, the signaling state 712 of the Data wire 702 is expected to remain constant for the duration of the pulses 714 when the Clock wire 704 is at a high voltage level. Transitions on the Data wire 702 when the Clock wire 704 is at the high voltage level indicate a START condition 706, a STOP condition 708 or a Repeated Start 710.

On an I3C serial bus, a START condition 706 is defined to permit the current bus master to signal that data is to be transmitted. The START condition 706 occurs when the Data wire 702 transitions from high to low while the Clock wire 704 is high. The bus master may signal completion and/or termination of a transmission using a STOP condition 708. The STOP condition 708 is indicated when the Data wire 702 transitions from low to high while the Clock wire 704 is high. A Repeated Start 710 may be transmitted by a bus master that wishes to initiate a second transmission upon completion of a first transmission. The Repeated Start 710 is transmitted instead of a STOP condition 708, and has the significance of a STOP condition 708 followed immediately by a START condition 706. The Repeated Start 710 occurs when the Data wire 702 transitions from high to low while the Clock wire 704 is high.

The bus master may transmit an initiator 722 that may be a START condition 706 or a Repeated Start 710 prior to transmitting an address of a slave, a command, and/or data. FIG. 7 illustrates a command code transmission 720 by the bus master. The initiator 722 may be followed in transmission by a predefined address header 724 and a command code 726. The command code 726 may, for example, cause the serial bus to transition to a desired mode of operation. In some instances, data 728 may be transmitted. The command code transmission 720 may be followed by a terminator 730 that may be a STOP condition 708 or a Repeated Start 710.

Certain serial bus interfaces support signaling schemes that provide higher data rates. In one example, I3C specifications define multiple high data rate (HDR) modes, including a high data rate, double data rate (HDR-DDR) mode in which data is transferred at both the rising edge and the falling edge of the clock signal.

An I3C bus may be switched between SDR and DDR modes. FIG. 7 includes an example of signaling 740 transmitted on the Data wire 702 and the Clock wire 704 to initiate certain mode changes. The signaling 740 is defined by I3C protocols for use in initiating restart, exit and/or break from I3C HDR modes of communication. The signaling 740 includes an HDR Exit 742 that may be used to cause an HDR break or exit. The HDR Exit 742 commences with a falling edge 744 on the Clock wire 704 and ends with a rising edge 746 on the Clock wire 704. While the Clock wire 704 is in a low signaling state, four pulses are transmitted on the Data wire 702. I2C devices ignore the Data wire 702 when no pulses are provided on the Clock wire 704.

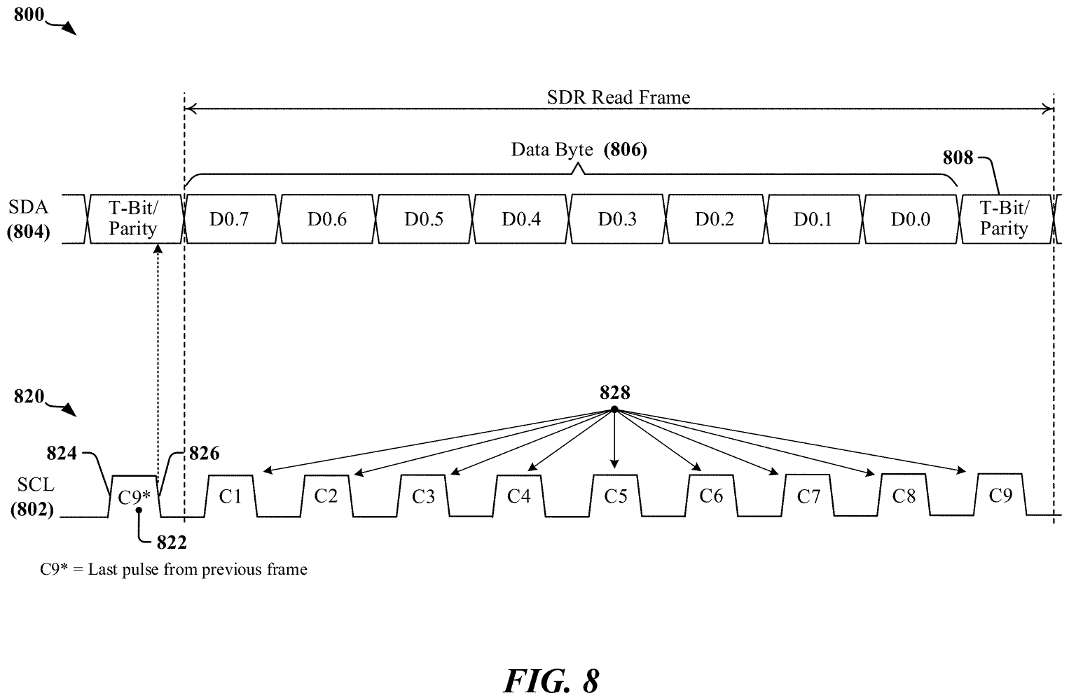

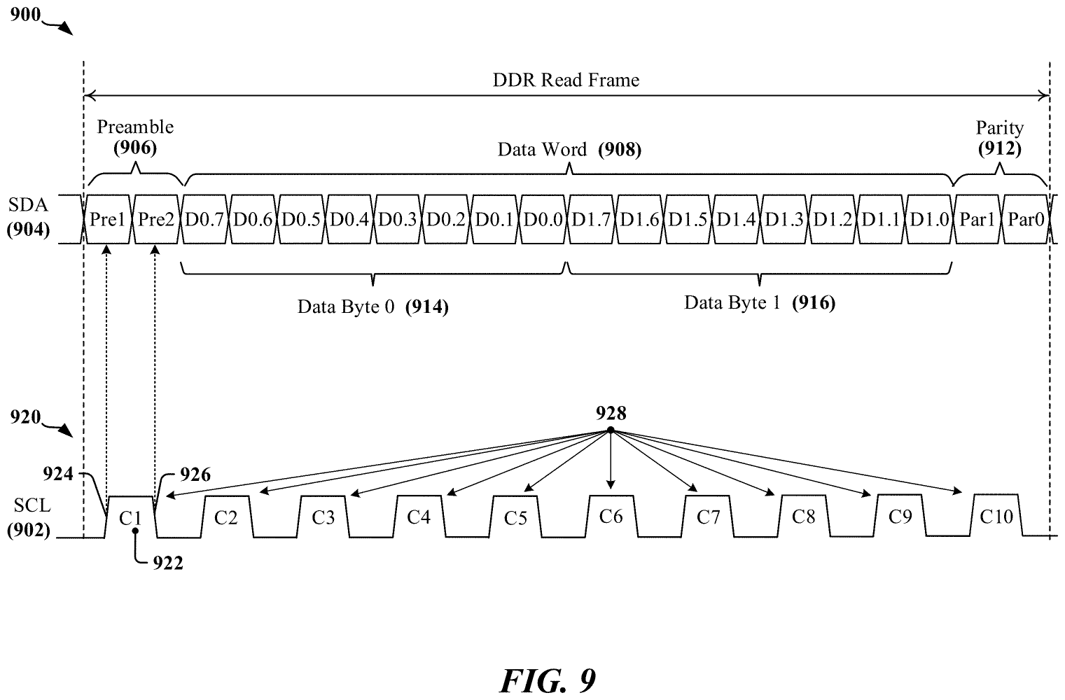

FIGS. 8 and 9 include timing diagrams that illustrate frames 800, 900 transmitted on a serial bus when a bus master device is reading from a slave device. The serial bus has a clock wire (SCL 802, 902) and a Data wire (SDA 804, 904). A clock signal 820, 920 transmitted on SCL 802, 902 provides timing information that can be used when the serial bus is operated in an I3C single data rate (SDR) mode and in an I3C HDR-DDR mode. The clock signal includes pulses 822, 828, 922, 928 that are defined by a rising edge 824, 924 and a falling edge 826, 926. A bus master device transmits the clock signal on the SCL 802, 902 regardless of the direction of flow of data over the serial bus.

FIG. 8 illustrates a frame 800 transmitted while the serial bus is operated in the I3C SDR mode. A single byte of data 806 is transmitted in each frame 800. The data signal transmitted on SDA 804 is expected to be stable for the duration of the high state of the pulses 828 in the clock signal 820 and, in one example, the state of SDA 804 is sampled on the falling edges of the clock pulses 828. Each byte of data 806 is followed by a bit 808 that can serve as a parity bit or a transition bit (T-Bit).

FIG. 9 illustrates a frame 900 transmitted while the serial bus is operated in the HDR-DDR mode. In the HDR-DDR mode, data is transferred at both the rising edge 924 and the falling edge 926 of a pulse 922 in the clock signal 920. A receiver samples or captures one bit of data on SDA 904 at each edge of the pulses 928 in the clock signal 920. A 2-byte data word 908 is transmitted in each frame 900 in the HDR-DDR mode. A data word 908 generally includes 16 payload bits, organized as two 8-bit bytes 914, 916 and the data word 908 is preceded by a two-bit preamble 906 and followed by two parity bits 912. The 20 bits in the frame 900 can be transferred on the edges of 10 clock pulses. The integrity of the transmission may be protected by the transmission of the parity bits 912.

In-Band Interrupts and Address Arbitration on a Serial Bus

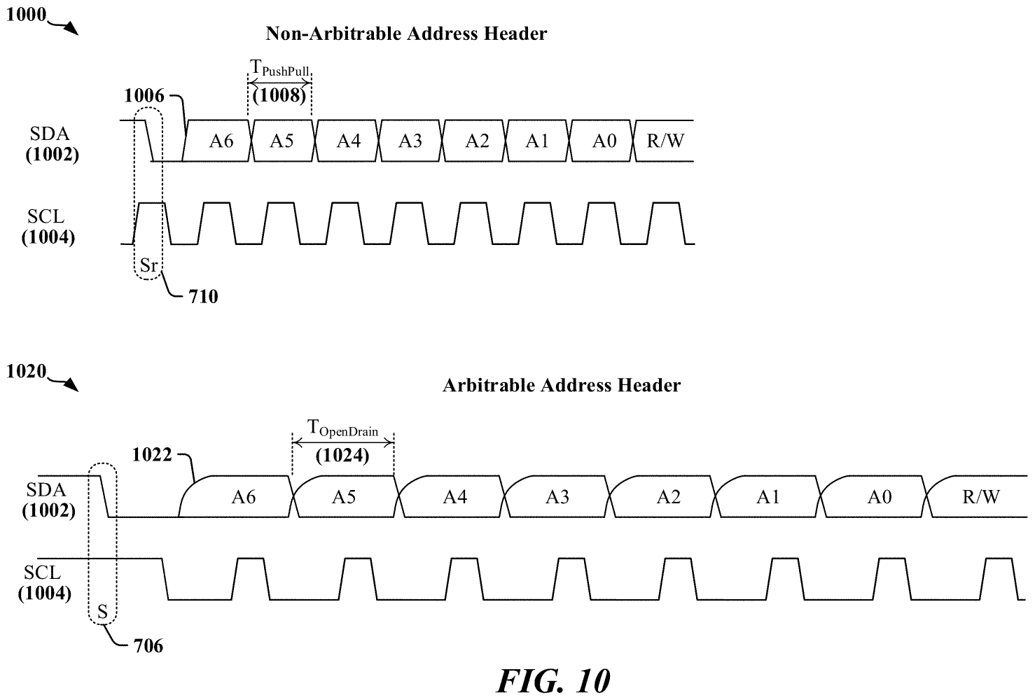

In-band interrupts may be used to gain access to an I3C bus in order to transmit high-priority and/or low-latency messages. A device other than the current bus master may assert an in-band interrupt during transmission of certain address fields to initiate an arbitration process that can enable the asserting device to gain access to a serial bus. The serial bus may be operated in a mode in which data is transmitted on a data line in accordance with timing provided by a clock signal transmitted on a clock line. FIG. 10 illustrates a non-arbitrable address header 1000 and an arbitrable address header 1020 that may be transmitted on the SDA line 1002 of the serial bus in accordance with I3C protocols. I3C protocols provide for different types of request to be transmitted using an I3C arbitrable address header. I3C arbitrable address headers 1020 are transmitted after a START condition 706. An address header 724 transmitted after a Repeated Start 710 is not arbitrable. A device may use an I3C arbitrable address header to assert an In-Band Interrupt, make a secondary master request, or indicate a hot-join request.

A non-arbitrable address header 1000 is transmitted using push-pull drivers, while open-drain drivers are enabled during transmission of an arbitrable address header 1020. Rising edges 1006 in a push-pull transmission provide a shorter bit interval 1008 than the bit interval 1024 available during an open-drain transmission, due to the slow rise time of the pulled-up edges 1022 in a non-arbitrable address header 1000. In FIG. 10, the bit intervals 1008, 1024 are not depicted on a common scale.

A clock signal transmitted on the SCL line 1004 provides timing information that is used by a slave device to control transmission of bits on the SDA line 1002, where the clock signal may be used by a receiving device for sampling and/or capturing bits of data transmitted on the SDA line 1002. A bus master device may read one or more registers on a slave device or secondary master device that wins arbitration. In conventional systems, the bus master device may provide clock pulses in a clock signal that have a period sufficient to successfully read the slowest possible device coupled to the serial bus. Each slave device has different operating characteristics and limitations that affect the response time of the slave device. In one example, the response time of a slave device may be affected by the physical distance between the slave device and the bus master device. In another example, the response time of a slave device may be affected by the processing capabilities of the slave device, where a slower controller, state machine or other processor in the slave device may delay responses transmitted by the slave device during in-band interrupt handling and/or processing.

Time-Division Multiplexing in a Serial Bus

Communication is generally conducted asynchronously over a serial bus that is compliant or compatible with conventional serial bus protocols such as I2C, I3C, RFFE and SPMI protocols. In certain applications, it may be beneficial or desirable for certain devices or groups of devices to communicate at regular, fixed or agreed time intervals. In such applications, it may be desirable to employ a common bus interface that supports multiple clients, some of which may engage in periodic data transfers. Certain data transfers may be tightly synchronized. Applications that require or benefit from synchronized communication may include applications that include or support audio transmissions and applications that service sensors and/or deliver or respond to repeating sensing events. A serial bus operated in accordance with conventional protocols may be unsuited for certain real-time, synchronous and/or synchronized applications. Conventional serial buses may be unavailable at the precise moments required by synchronous applications and do not support the assignment of time slots for the use of client devices. Conventional bus protocols provide no techniques for informing clients of assigned time slots, for maintaining timing that permits transmission of blocks at precise moments, or for a master device to manage client time slots such that the client time slots occur at precise moments.

According to certain aspects disclosed herein, a repetitive time period (RTP) may be implemented for communication over a serial bus. In one example, dedicated time slots are defined within one or more RTP transactions for each client device coupled to the serial bus. A bus master device can configure an RTP schedule using command codes in headers transmitted in a transaction between the bus master device and one or more client slave devices. The header may include information that signals the start of an RTP transaction and/or a beginning of a set of timeslots assigned to a client slave device. In some instances, the header indicates whether a write or read is to be performed and may identify one or more slave devices that are to perform a write or a read. The header may include information that identifies the length of a read or write transaction, where the length may be expressed in a number of bytes or words.

According to certain aspects disclosed herein, an active bus master device controls RTP operations. The active bus master device may manage the scheduling of RTP transactions and may initiate one or more RTP transactions in accordance with a schedule. RTP transactions may include RTP configuration transactions and RTP RUN transactions. One or more slave devices may be configured to transmit a preconfigured amount of data in an RTP slot within the RTP transaction. A slave device may be configured with timing information identifying the position of each of its RTP slots with respect to the start of the RTP transaction. The slave device may then simply count clock cycles to determine when it can transmit or receive data in one or more RTP slots. More than one timeslot in an RTP transaction may be assigned to a slave device, and the assigned RTP timeslots need not be assigned adjacent in time.

Multiple RTP instances may be defined. In one example, two RTP instances may be defined with different periodicities, where a first RTP instance (RTPj) is configured such that a corresponding RTP RUN transaction is repetitively executed at a first frequency, and a second RTP instance (RTPk) is configured such that a corresponding RTP RUN transaction is repetitively executed at a second frequency. In another example, two RTP instances may be defined with different configurations of slave devices and/or different assignments of timeslots to one or more slave devices.

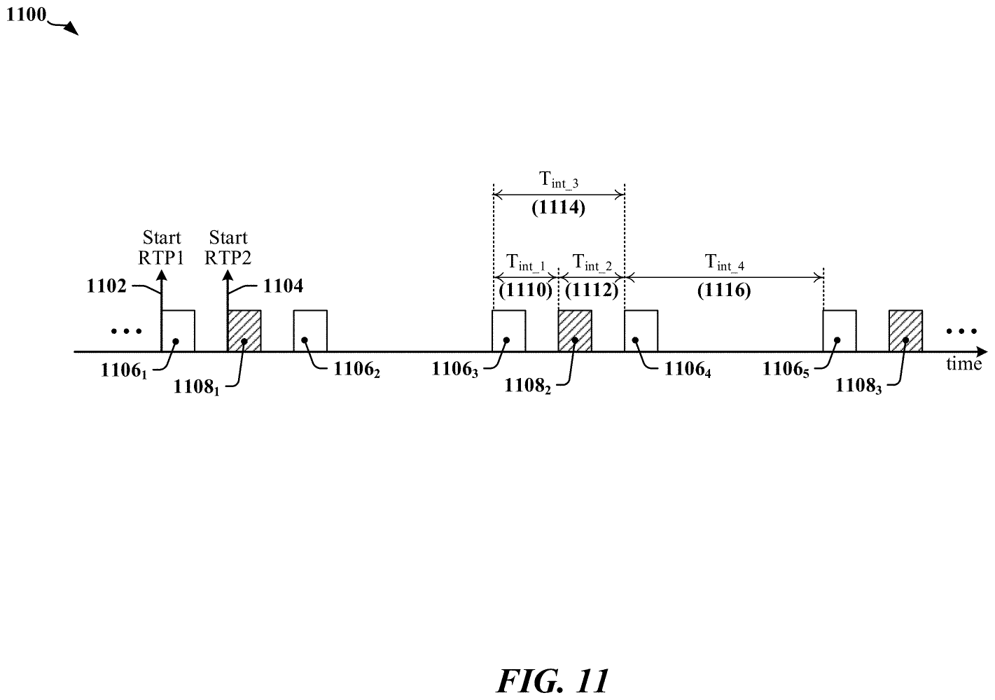

FIG. 11 illustrates an example of timing 1100 when two RTP instances are configured and enabled. A first RTP configuration defines a schedule for RTP transactions 1106₁-1106₅ that occur more frequently than RTP transactions 1108₁-1108₃ that are defined by a second RTP configuration. The first RTP configuration is enabled at a first time 1102 and the second RTP configuration is enabled at a second time 1104. The first RTP configuration and the second RTP configuration may have a common periodicity, whereby certain RTP transactions 1106₁, 1106₃, 1106₅ are scheduled by the first RTP configuration to occur at a time that precedes RTP transactions 1108₁, 1108₂, 1108₃ scheduled by the second RTP configuration by a first interval 1110, and other RTP transactions 1106₂, 1106₄ are scheduled by the first RTP configuration to occur at a time that follows the RTP transactions 1108₁, 1108₂, 1108₃ scheduled by the second RTP configuration by a second interval 1112. The two intervals 1110, 1112 can be the same or different. In some examples, the RTP transactions 1106₁-1106₅, and/or 1108₁-1108₃ may occur at evenly-spaced intervals. In some examples, scheduling may be irregular. For example, the RTP transactions 1106₁-1106₅ scheduled by the first RTP configuration include RTP transactions 1106₃ and 1106₄ spaced by a third interval 1114 that is different from a fourth interval 1116 that separates other RTP transactions 1106₄ and 1106₅ scheduled by the first RTP configuration.

A bus master device responsible for managing RTP transactions may be referred to herein as an RTP bus master. The RTP bus master may ensure that the serial bus is available for conducting an RTP transaction. For example, an RTP bus master engaged in an ongoing non-RTP transaction may terminate such ongoing transmissions before an RTP slot is scheduled to begin. The RTP bus master may disable or reject interrupt requests to provide an uninterrupted RTP process.

In an example where a serial bus is operated in accordance with an I3C protocol, the RTP bus master can schedule and initiate RTP transactions, and can operate the serial bus in a manner that ensures that the bus is available for the RTP transactions. In one example, the RTP bus master may interrupt a transfer between a secondary bus master and a slave device in order to gain control of the serial bus. The RTP bus master may prohibit interrupts by other devices when the RTP bus master has control of the serial bus. When in control of the serial bus, the RTP bus master may stall serial bus operations until a scheduled RTP transaction is to begin.

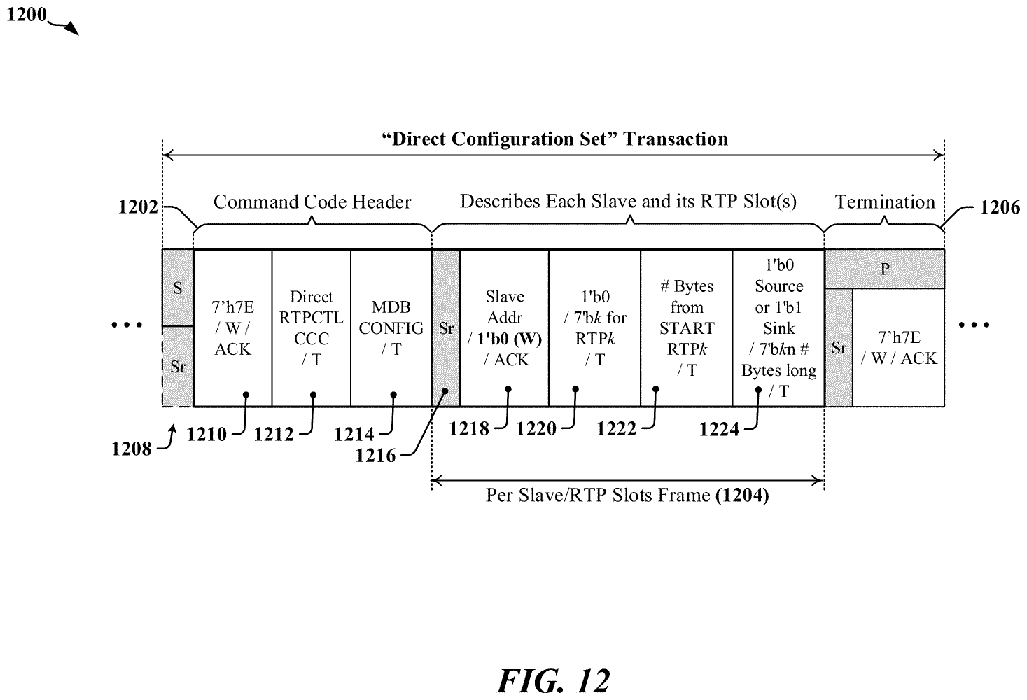

FIGS. 12-15 illustrate examples of transactions 1200, 1300, 1400, 1500 transmitted over a serial bus to configure RTP operations in a slave device in accordance with certain aspects disclosed herein. In the illustrated examples, the serial bus is operated in accordance with an I3C protocol. Each transaction 1200, 1300, 1400, 1500 includes a common command code (CCC) dedicated or reserved for RTP operations. The transmission of a header that includes an I3C CCC can add a 2 μs or 3.5 μs delay at the commencement of an RTP transaction. In some implementations, the RTP bus master times the initiation of transmission to accommodate the delays and latencies that can be expected when launching an RTP transaction.

FIG. 12 illustrates an RTP Direct Set transaction 1200 that may be used to define an RTP configuration in one or more slave devices. The RTP Direct Set transaction 1200 may include multiple RTP SET frames 1204, each RTP SET frame 1204 configuring one RTP timeslot associated with one slave device. The RTP Direct Set transaction 1200 is transmitted after an initiator 1208 that may be a START or Restart condition, and includes a command code header 1202 in the form of the command code transmission 720 illustrated in FIG. 7, and the RTP Direct Set transaction 1200 is completed by a termination sequence 1206. The initiator 1208 may be followed in transmission by an address header 1210 and an RTP control (RTPCTL) CCC 1212. The command code header 1202 may include a configuration byte 1214.

The command code header 1202 is followed by one or more RTP SET frames 1204 that carry configuration information directed to one or more slaves. In each RTP SET frame 1204, a repeated start 1216 precedes the configuration frame for a slave and one of its associated RTP timeslots. An identifier field 1218 includes a slave address for the slave device to receive the RTP configuration and a Read/Write′ (RnW) bit set to 1′b0 indicating an RTP SET frame 1204.

Three data bytes characterizing an RTP timeslot are provided for each addressed slave device. One RTP timeslot is defined for each RTP SET frame 1204. A first configuration byte 1220 has the format {1′b0, 7′bk}, where “k” identifies the following bytes as related to the kth RTP (RTPk) instance. A second configuration byte 1222 defines the position of the configured RTP timeslot. In one example, the position of the configured RTP timeslot is expressed as a number of bytes between a defined start point in the RTP RUN transaction and the respective RTP timeslot in the addressed slave device. A third configuration byte 1224 defines the length of the respective RTP timeslot. The third configuration byte 1224 may have the format: {1′b1, RnW, 7′bk}, where k represents the duration of the timeslot, expressed in bytes, and where the value of RnW indicates when the slave device is a source (e.g., RnW==1′b0) and when the slave device is a sink (e.g., RnW==1′b1).

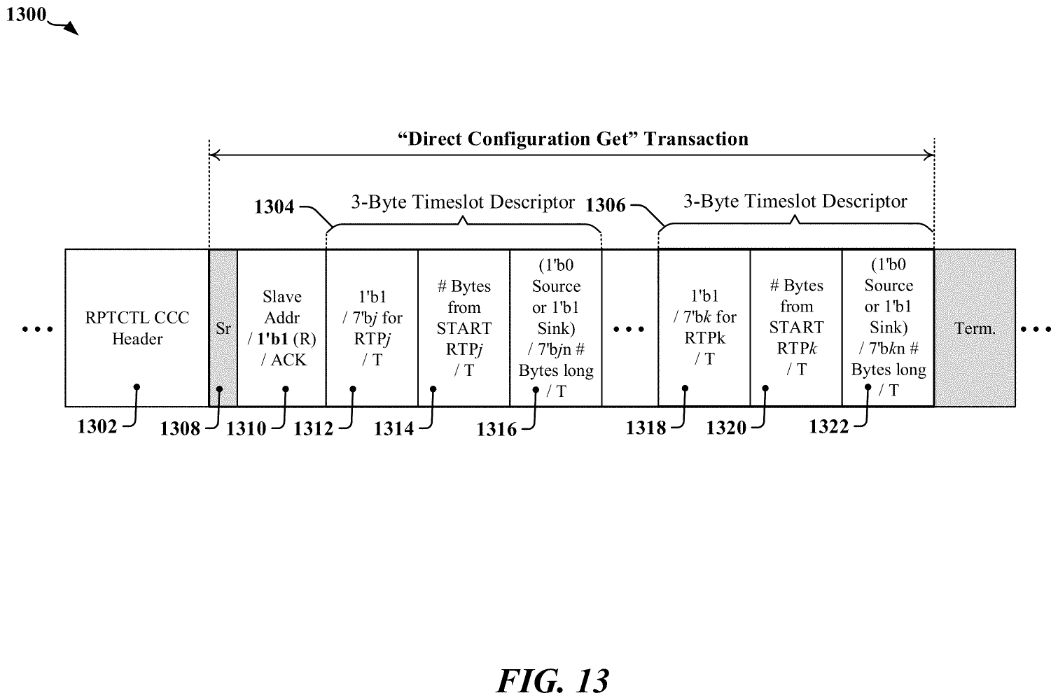

FIG. 13 illustrates an RTP Direct Get transaction 1300 that may be used by an RTP bus master to read an RTP configuration stored in a slave device. The RTP Direct Get transaction 1300 is executed after an RTPCTL command code header 1302. The command code header 1302 is followed by RTP GET commands directed to one or more slaves. A repeated start 1308 precedes the frame for each slave device and its associated timeslots. An identifier field transmitted in a byte 1310, 1318 includes a slave address and a Read/Write′ (RnW) bit, which is set to 1′b1 to indicate an RTP GET frame. The RTP GET frame includes one or more RTP timeslot descriptors 1304, 1306 that carry the configuration information maintained by the addressed slave device for its associated RTP timeslots.

In the illustrated example, RTP timeslot descriptors 1304, 1306 transmitted in the RTP GET frame by the addressed slave device include three data bytes characterizing each RTP timeslot associated with the addressed slave device. A first configuration byte 1312, 1320 has the format {1′b0, 7′bx}, where x identifies the RTP instance. In the example, two RTP instances (RTPj and RTPk) are configured. A second configuration byte 1314, 1322 defines the position of the respective configured RTP timeslot. In one example, the position of a configured timeslot is expressed as a number of bytes between a defined start point in the RTP RUN transaction and the respective RTP timeslot in the addressed slave device. A third configuration byte 1316, 1322 defines the length of the respective RTP timeslot in the addressed slave device. The third configuration byte 1316, 1322 may have the format: {1′b1 RnW, 7′bn}, where n is the duration of the timeslot, expressed in bytes, and where the value of RnW indicates when the slave device is a source (e.g., RnW 1′b0) and when the slave device is a sink (e.g., RnW==1′b1).

The addressed slave device provides the three bytes 1312, 1314, 1316, or 1318, 1320, 1322 for each RTP slot previously configured by the RTP bus master. The slave device completes a read operation using a T-bit function. Multiple RTP timeslot descriptor 1304, 1306 can be sent in succession, within the same RTP GET frame.

According to certain aspects disclosed herein, an active bus master device may provide timing information that can be used to correct and/or synchronize slave clocks with the clock used by the active bus master device to control or schedule RTP operations. The timing information may be provided in RTP transactions. The timing information may be transmitted to one or more slave devices. The timing information may relate to one or more RTP slots. A slave device may adjust its timing source in response to an RTP Set transaction. A slave device may report its RTP timing configuration in response to an RTP Get transaction, where the RTP timing configuration may be expressed as one or more offsets used to adjust internally produced timing intervals to conform with timing intervals defined by the active bus master device. In one example, the slave device may use a counter that counts clock cycles to determine when it can transmit or receive data in one or more RTP slots, and the RTP timing configuration may define a value to be added or subtracted from the number of cycles to be counted by the counter when measuring an interval. In some instances, the RTP timing configuration may define multiple offset values when more than one timeslot in an RTP transaction has been assigned to the slave device.

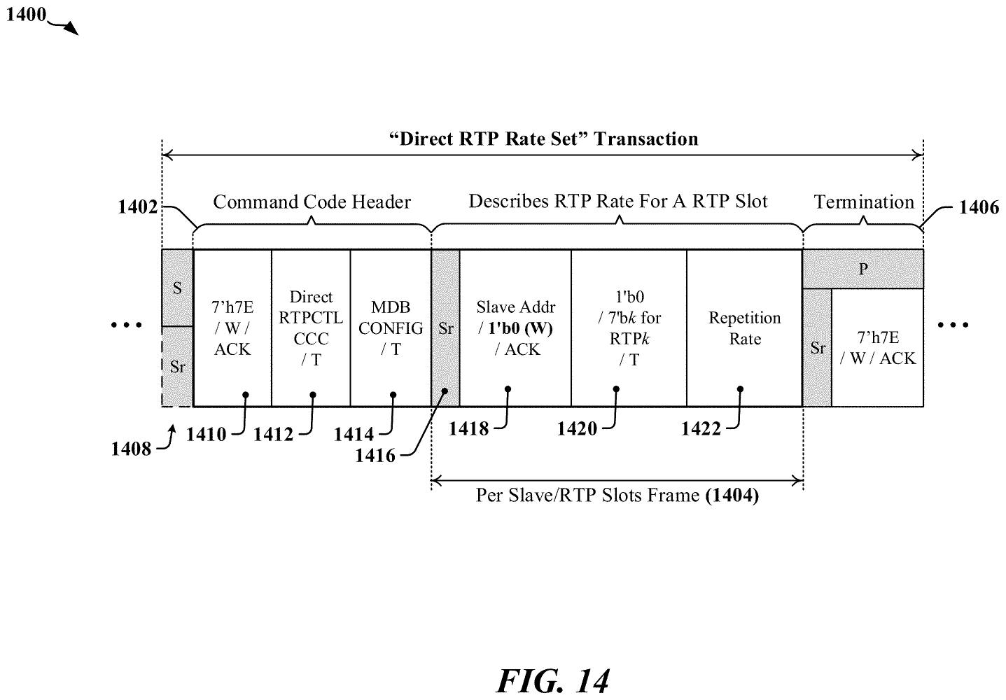

FIG. 14 illustrates a Direct RTP Rate Set transaction 1400 that may be used to define an RTP timing configuration to be used by one or more slave devices. The Direct RTP Rate Set transaction 1400 may include multiple RTP Rate SET frames 1404, each RTP Rate SET frame 1404 configuring timing associated with one RTP timeslot for one slave device. The Direct RTP Rate Set transaction 1400 is transmitted after an initiator 1408 that may be a START or Restart condition, and includes a command code header 1402 in the form of the command code transmission 720 illustrated in FIG. 7, and the Direct RTP Rate Set transaction 1400 is completed by a termination sequence 1406. The initiator 1408 may be followed in transmission by an address header 1410 and an RTP control (RTPCTL) CCC 1412. The command code header 1402 may include a configuration byte 1414.

The command code header 1402 is followed by one or more RTP Rate SET frames 1404 that carry timing configuration information directed to one or more slaves. In each RTP Rate SET frame 1404, a repeated start 1416 precedes the timing configuration frame for a slave and one of its associated RTP timeslots. An identifier field 1418 includes a slave address for the slave device to receive the RTP timing configuration and a Read/Write′ (RnW) bit set to 1′b0 indicating an RTP Rate SET frame 1404.

In the illustrated example, two data bytes may be provided in each RTP Rate SET frame 1404 to configure RTP timing for an RTP timeslot in an addressed slave device. In some implementations, more than two data bytes may be provided in each RTP Rate SET frame 1404. In some implementations, the number of data bytes provided in each RTP Rate SET frame 1404 may be defined by the bus master or by an application. A first timing configuration byte 1420 has the format {1′b0, 7′bk}, where “k” identifies the following byte as providing timing information related to the kth RTP (RTPk) instance. A second timing configuration byte 1422 provides information that allows the slave device to adjust its internal timing. In one implementation, the second timing configuration byte 1422 defines the periodicity of the kth RTP. For example, the active master device may transmit an RTP Rate SET frame 1404 that defines the periodicity of the kth RTP as 2 ms. The slave device can then calibrate or correct its internal timing circuits to enable it to more accurately determine when the next kth RTP slot is to occur. In another implementation, the second timing configuration byte 1422 may define an offset to be used by a slave device to configure a timer or counter that permits the slave device to determine when the next kth RTP slot is to occur. For example, when the periodicity of the kth RTP is set by the master device to 2 ms, the master device may read the counter or another register of the slave device at the midpoint between kth RTP slots, or at another point between kth RTP slots to determine the accuracy of timing circuits used by the slave device. The active master device may then transmit an RTP Rate SET frame 1404 to provide offsets or other corrective information to the slave device.

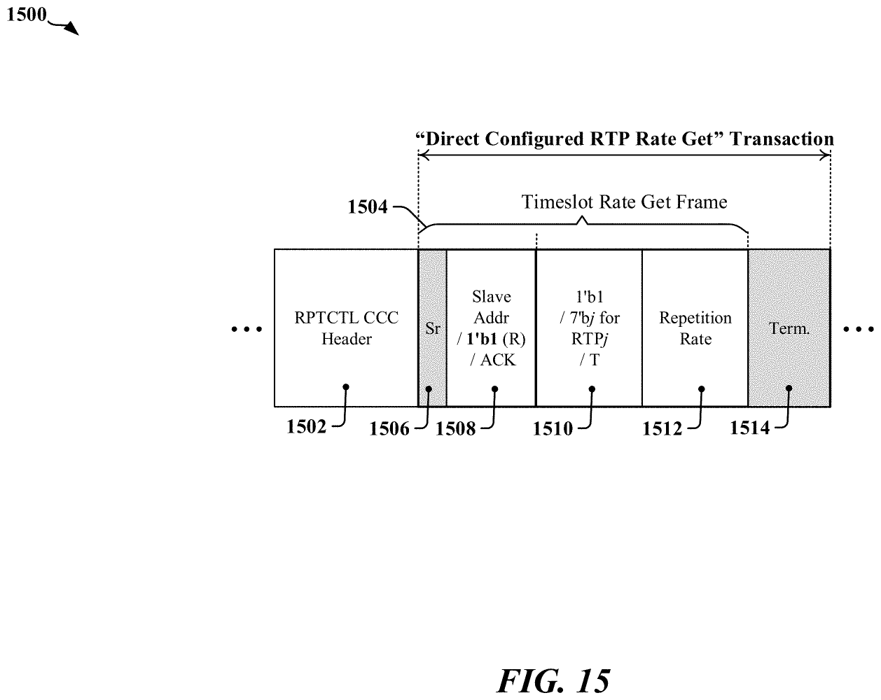

FIG. 15 illustrates a Direct RTP Rate Get transaction 1500 that may be used by an RTP bus master to read an RTP configuration stored in a slave device. The Direct RTP Rate Get transaction 1500 is initiated after an RTPCTL command code header 1502. The command code header 1502 is followed by RTP Rate GET commands directed to one or more slaves. A repeated start 1506 precedes the frame for each slave device and its associated timeslots. An identifier field 1508 includes a slave address and a Read/Write′ (RnW) bit, which is set to 1′b1 to indicate an RTP Rate GET frame. The Direct RTP Rate Get transaction 1500 can be used to retrieve RTP timeslot rate information for one or more RTP timeslots configured for the addressed slave device. The Direct RTP Rate Get transaction 1500 ends with a termination sequence 1514.

In the illustrated example, RTP Rate Get frame 1504 includes two timing definition data bytes characterizing each RTP timeslot, including one byte transmitted by the slave device. In some implementations, more than one timing definition byte may be provided in each RTP Rate GET frame 1504. In some implementations, the number of timing definition bytes provided in each RTP Rate GET frame 1504 may be configured by the bus master or by an application. A first timing definition byte 1510 is transmitted by the master device and has the format {1′b1, 7′bx}, where x identifies the RTP instance and a read operation (GET). A second timing definition byte 1512 is transmitted by the slave device and provides information that indicates the offsets used by the slave device to adjust its internal timing. In one implementation, the second timing definition byte 1512 indicates a periodicity of the kth RTP that was previously configured by the active bus master. For example, the active master device may have transmitted an RTP Rate SET frame 1404 that defined the periodicity of the kth RTP as 2 ms. The slave device may have calibrated or corrected its internal timing circuits to enable it to more accurately determine when the next kth RTP slot is to occur. In another implementation, the second timing definition byte 1512 may be transmitted by the slave device to indicate an offset used by the slave device to configure a timer or counter that permits the slave device to determine when the next kth RTP slot is to occur. In another implementation, the second timing definition byte 1512 may be transmitted by the slave device to indicate counter or timer value indicative of the expected occurrence of the next kth RTP slot. The active master device may transmit an RTP Rate GET frame 1504 to read the offsets or other corrective information from the slave device. For example, when the periodicity of the kth RTP is set by the master device to 2 ms, the master device may read the counter or another register of the slave device at the midpoint of an interval between kth RTP slots, or at another point between kth RTP slots to determine the accuracy of timing circuits used by the slave device. The active master device may then transmit an RTP Rate SET frame 1404 to provide new or different offsets or other corrective information to the slave device.

In various implementations, RTP transactions are initiated by an RTP bus master. The RTP bus master may manage an RTP instance or configuration in which an RTP transaction is executed periodically. The RTP bus master may be configured to terminate ongoing transmissions and/or stall bus activities prior to the defined starting time for an RTP transaction to obtain a desired or required precision in the timing of RTP transactions, and in the timing of timeslots assigned to the slave devices associated with the RTP instance. In some implementations, RTP transactions may be initiated asynchronously. For example, an RTP instance may be configured to enable a group of slave devices to exchange sensor information after a triggering event provided by one or more sensors, and/or an application. In the latter example, an RTP bus master may initiate an RTP transaction in response to a request received from an application or in response to an in-band interrupt received from another device. A mandatory data byte (MDB) transmitted by the device asserting the in-band interrupt may indicate the request for an RTP transaction with an identifier of the RTP instance.

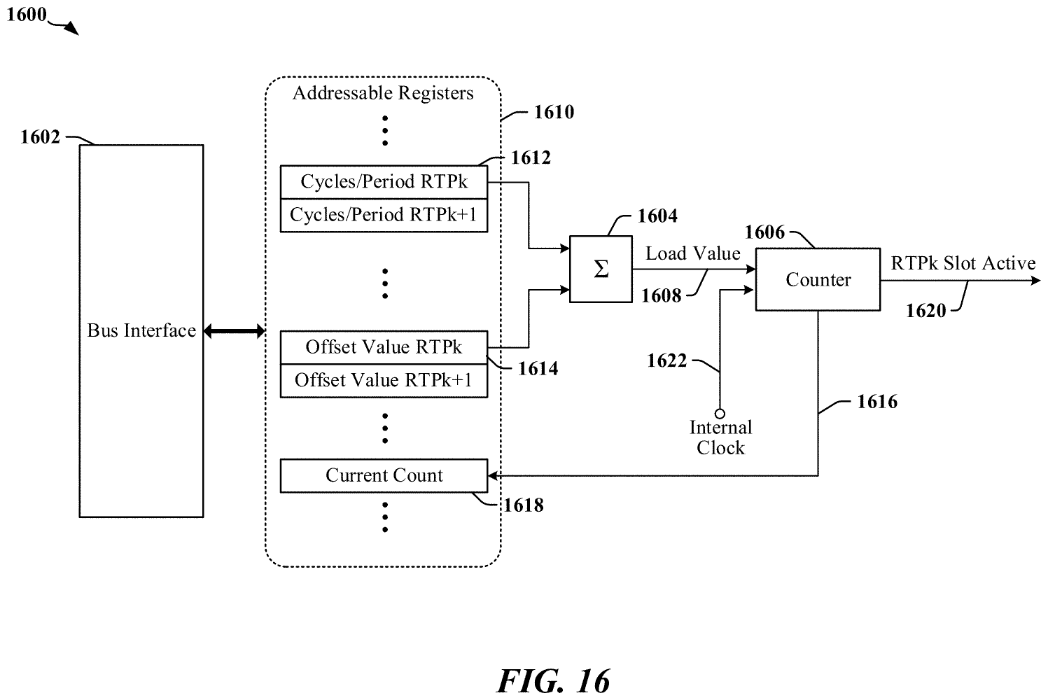

FIG. 16 illustrates and example of a timing circuit 1600 in a slave device that is configured to support RTP in accordance with certain aspects disclosed herein. This example illustrates one technique for timing the periodicity of RTP slots. In some implementations, the timing circuit 1600 includes a counter for each type of RTP slot. In some implementations, the timing of different types of RTP slot may be monitored using a single counter that is configured to time the intervals between different types of RTP slot. In some implementations, the timing circuit 1600 includes one or more comparators that compare the output of the counter with count values that match a period of a corresponding type of RTP slot.

In the illustrated timing circuit 1600, a countdown counter 1606 is loaded with a count value 1608 that represents the number of cycles expected between occurrences of RTP slots of the same type. The count value 1608 may be calculated as the sum of a base value maintained in a first register 1612 and an offset value maintained in a second register 1614. The content of the first register 1612 and the second register 1614 may be added using an adder 1604 or other logic. The offset value may be represented as a 7-bit signed integer, for example. The countdown counter 1606 may be clocked by an internal clock signal 1622 that can change over time due to process, voltage and temperature (PVT) variations. The timing circuit 1600 can accommodate PVT variations using the offset value in the second register 1614, which may be calculated and/or updated by the slave device or provided by a bus master device. The base value maintained in the first register 1612 may also be calculated and/or updated by the slave device or provided by a bus master device, and represents the number of clock cycles that correspond to the period of a type of RTP slot.

The first register 1612 and the second register 1614 may be provided using a set of registers 1610 that are addressable over the bus, whereby commands received by a bus interface circuit 1602 may be addressed directly to the first register 1612 and the second register 1614, and other registers. In some implementations, the slave device may translate register addresses between internal addresses and addresses available to the bus interface circuit 1602. The set of registers 1610 may include or allocate base and offset registers for tracking periodicity of each type of RTP slot.

The set of registers 1610 may include one or more registers 1618 that are used to allow the bus master, or another device coupled to the serial bus, to read the current value 1616 of the countdown counter 1606. In one example, the bus master may use these registers 1618 to determine and/or correct for loss of calibration.

The timing circuit 1600 may provide one or more output signals 1620 that indicate that an RTP slot is occurring, or is about to occur. In one example, the output signals 1620 correspond to an output of a countdown counter 1606 that indicates when the countdown counter 1606 registers a zero value. In another example, the output signals 1620 correspond to an overflow or carry signal provided by the countdown counter 1606. In one example, the output signals 1620 are generated by logic circuits coupled to the countdown counter 1606, where the logic circuits may be responsive to signals identifying RTP instance for example. In some implementations, the output signals 1620 can be used to cause circuits within the slave device to exit an idle or sleep mode. In some implementations, the output signals 1620 can be used to cause circuits within the slave device to prefetch information that is to be provided during an associated RTP slot. In some instances, early warning indications of occurrence of RTP slot can be relatively imprecise, and in such instances the slave device may use a coarser timing correction technique. For example, the slave device may maintain a counter value that represents a duration of time that is significantly shorter than the period between RTP slots, such that the counter can be initiated at some time between the beginning and end of an RTP slot without the need for calibration.

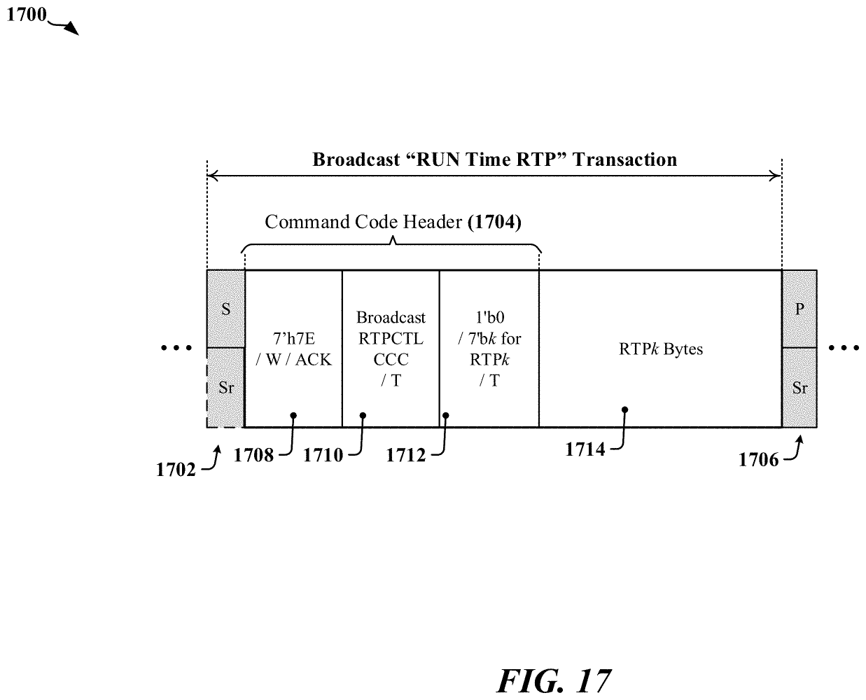

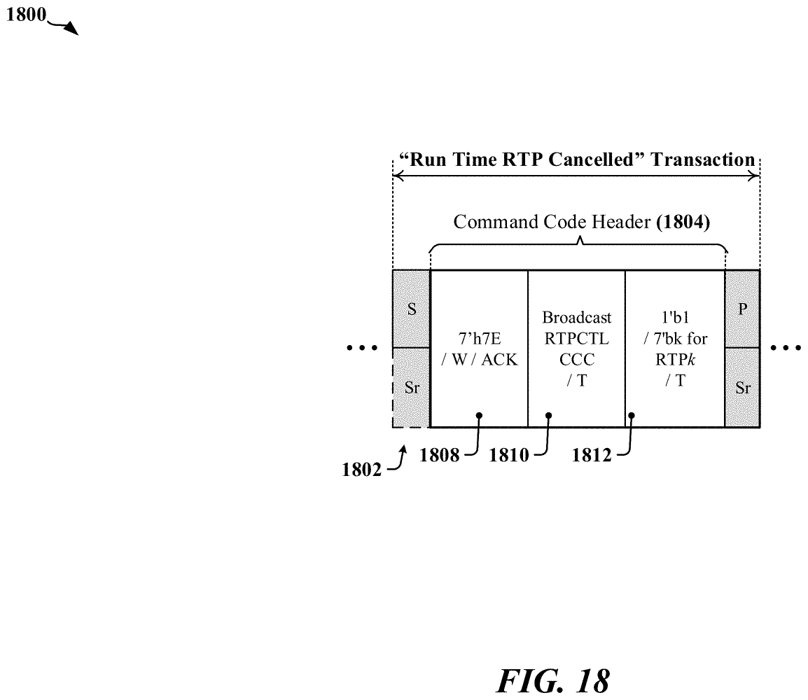

FIGS. 17 and 18 illustrate examples of RTP transactions 1700, 1800 transmitted over a serial bus to configure RTP operations in a slave device in accordance with certain aspects disclosed herein. In the illustrated examples, the serial bus is operated in accordance with an I3C protocol. Each RTP transaction 1700, 1800 includes a common command code (CCC) dedicated or reserved for RTP operations. The transmission of a header that includes an I3C CCC can add a 2 μs or 3.5 μs delay at the commencement of an RTP transaction. In some implementations, the RTP bus master times the initiation of transmission to accommodate the delays and latencies that can be expected when launching an RTP transaction.

FIG. 17 is a first example of an RTP RUN transaction. The Start RTP transaction 1700 is transmitted by an RTP bus master to initiate a scheduled RTP transaction. In the Start RTP transaction 1700, the RTP bus master transmits an initiator 1702 that may be a START or Restart condition, followed by a command code header 1704 in the form of the command code transmission 720 illustrated in FIG. 7. The initiator 1702 may be followed in transmission by an address header 1708 indicating a broadcast RTPCTL CCC 1710. The command code header 1704 may include an indicator 1712 that indicates the RTP instance related to the RTP transaction. In the illustrated example, the indicator 1712 has the form: {1′b0, 7′bk}, where the 1′b0 identifies the broadcast RTPCTL CCC 1710 as a run-initiating command, and the remaining 7 bits identify the RTP instance (k). The indicator 1712 may be identical or at least similar in form to the MDB transmitted during an in-band interrupt asserted to initiate the RTP transaction. The command code header 1704 may be followed by data transactions 1714 transmitted in a number of RTP slots, with a termination 1706 being transmitted after the data transactions 1714. The RTP bus master may be configured to provide a sufficient number of successive clock pulses or period in the clock signal to enable the devices associated with the RTP configuration to exchange data in their allocated timeslots.

The RTP bus master provides an appropriate number of clock pulses to enable completion of the RTP transaction. A slave device may transmit or receive data during one or more assigned timeslots during the RTP transaction. The slave devices may count clock pulses and determine the temporal location of the timeslots with respect to a start point in the transaction. In one example, a slave device may start counting clock pulses after the indicator 1712 has been transmitted.

FIG. 18 is a second example of an RTP RUN transaction. The Stop RTP transaction 1800 is transmitted by an RTP bus master to cancel or terminate a scheduled RTP transaction. In the illustrated example, the Stop RTP transaction 1800 is transmitted to cancel transmission of all RTP slots for the RTPk configuration. The RTPk configuration may define a repetitive period at which RTP transactions are to be scheduled, and the relative timing of dedicated timeslots for each of the participants to that RTPk configuration. The Stop RTP transaction 1800 can be used to terminate any subsequent scheduled RTP transactions for the RTPk configuration. In one example, the Stop RTP transaction 1800 may be used to liberate the bus and/or remove the monitoring overhead from slave devices associated with tracking the RTPk schedule. The Stop RTP transaction 1800 may be used after a Start RTP transaction 1700 has been transmitted. The Start RTP transaction 1700 has the effect of enabling of RTPk. In some instances, the Stop RTP transaction 1800 may be sent when no preceding Start RTP transaction 1700 has been sent. In some instances, repeated Stop RTP transaction 1800 may be sent to ensure that slave devices are aware that the RTPk configuration is disabled.

In the Stop RTP transaction 1800, the RTP bus master transmits an initiator 1802 that may be a START or Restart condition, followed by a command code header 1804 in the form of the command code transmission 720 illustrated in FIG. 7. The initiator 1802 may be followed in transmission by an address header 1808 indicating a broadcast RTPCTL CCC 1810. The command code header 1804 may include an indicator 1812 that indicates the RTP instance to be cancelled. In the illustrated example, the indicator 1812 has the form: {1′b1, 7′bk}, where the 1′b1 identifies the broadcast RTPCTL CCC 1810 as a cancelling command, and the remaining 7 bits identify the RTP instance (k).

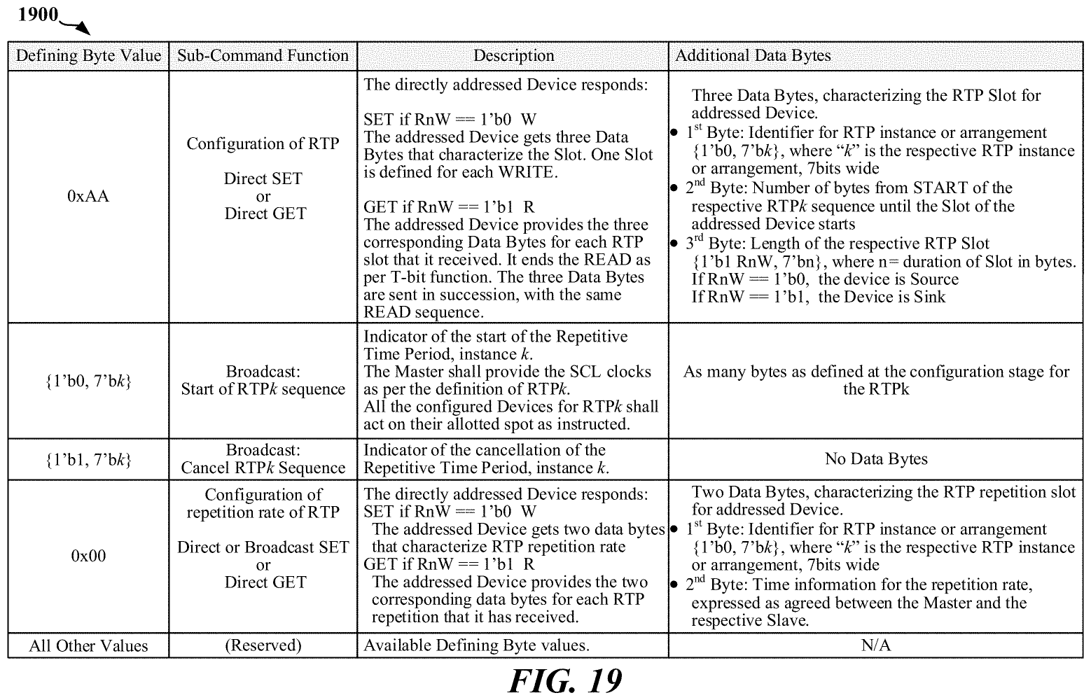

The form and structure of the RTPCTL CCC may be selected based on application needs and evolving bus specifications and protocols. FIG. 19 is a table 1900 illustrating an example of bit and byte assignments for RTPCTL CCCs implemented in an I3C interface.

Examples of Processing Circuits and Methods

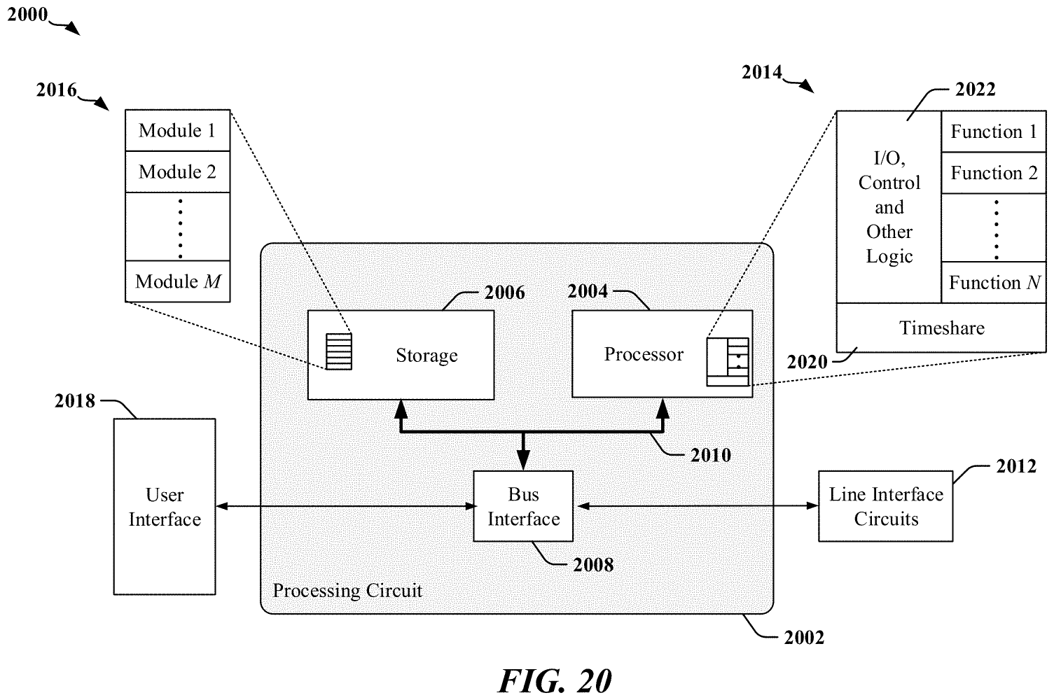

FIG. 20 is a diagram illustrating an example of a hardware implementation for an apparatus 2000 employing a processing circuit 2002 that may be configured to perform one or more functions disclosed herein. In accordance with various aspects of the disclosure, an element, or any portion of an element, or any combination of elements as disclosed herein may be implemented using the processing circuit 2002. The processing circuit 2002 may include one or more processors 2004 that are controlled by some combination of hardware and software modules. Examples of processors 2004 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 2004 may include specialized processors that perform specific functions, and that may be configured, augmented or controlled by one of the software modules 2016. The one or more processors 2004 may be configured through a combination of software modules 2016 loaded during initialization, and further configured by loading or unloading one or more software modules 2016 during operation. In various examples, the processing circuit 2002 may be implemented using a state machine, sequencer, signal processor and/or general-purpose processor, or a combination of such devices and circuits.

In the illustrated example, the processing circuit 2002 may be implemented with a bus architecture, represented generally by the bus 2010. The bus 2010 may include any number of interconnecting buses and bridges depending on the specific application of the processing circuit 2002 and the overall design constraints. The bus 2010 links together various circuits including the one or more processors 2004, and storage 2006. Storage 2006 may include memory devices and mass storage devices, and may be referred to herein as computer-readable media and/or processor-readable media. The bus 2010 may also link various other circuits such as timing sources, timers, peripherals, voltage regulators, and power management circuits. A bus interface 2008 may provide an interface between the bus 2010 and one or more transceivers 2012. A transceiver 2012 may be provided for each networking technology supported by the processing circuit. In some instances, multiple networking technologies may share some or all of the circuitry or processing modules found in a transceiver 2012. Each transceiver 2012 provides a means for communicating with various other apparatus over a transmission medium. Depending upon the nature of the apparatus 2000, a user interface 2018 (e.g., keypad, display, speaker, microphone, joystick) may also be provided, and may be communicatively coupled to the bus 2010 directly or through the bus interface 2008.

A processor 2004 may be responsible for managing the bus 2010 and for general processing that may include the execution of software stored in a computer-readable medium that may include the storage 2006. In this respect, the processing circuit 2002, including the processor 2004, may be used to implement any of the methods, functions and techniques disclosed herein. The storage 2006 may be used for storing data that is manipulated by the processor 2004 when executing software, and the software may be configured to implement any one of the methods disclosed herein.

One or more processors 2004 in the processing circuit 2002 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 2006 or in an external computer-readable medium. The external computer-readable medium and/or storage 2006 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 2006 may also include, by way of example, a carrier wave, a transmission line, and any other suitable medium for transmitting software and/or instructions that may be accessed and read by a computer. Computer-readable medium and/or the storage 2006 may reside in the processing circuit 2002, in the processor 2004, external to the processing circuit 2002, or be distributed across multiple entities including the processing circuit 2002. The computer-readable medium and/or storage 2006 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 2006 may maintain software maintained and/or organized in loadable code segments, modules, applications, programs, etc., which may be referred to herein as software modules 2016. Each of the software modules 2016 may include instructions and data that, when installed or loaded on the processing circuit 2002 and executed by the one or more processors 2004, contribute to a run-time image 2014 that controls the operation of the one or more processors 2004. When executed, certain instructions may cause the processing circuit 2002 to perform functions in accordance with certain methods, algorithms and processes described herein.

Some of the software modules 2016 may be loaded during initialization of the processing circuit 2002, and these software modules 2016 may configure the processing circuit 2002 to enable performance of the various functions disclosed herein. For example, some software modules 2016 may configure internal devices and/or logic circuits 2022 of the processor 2004, and may manage access to external devices such as the transceiver 2012, the bus interface 2008, the user interface 2018, timers, mathematical coprocessors, and so on. The software modules 2016 may include a control program and/or an operating system that interacts with interrupt handlers and device drivers, and that controls access to various resources provided by the processing circuit 2002. The resources may include memory, processing time, access to the transceiver 2012, the user interface 2018, and so on.

One or more processors 2004 of the processing circuit 2002 may be multifunctional, whereby some of the software modules 2016 are loaded and configured to perform different functions or different instances of the same function. The one or more processors 2004 may additionally be adapted to manage background tasks initiated in response to inputs from the user interface 2018, the transceiver 2012, and device drivers, for example. To support the performance of multiple functions, the one or more processors 2004 may be configured to provide a multitasking environment, whereby each of a plurality of functions is implemented as a set of tasks serviced by the one or more processors 2004 as needed or desired. In one example, the multitasking environment may be implemented using a timesharing program 2020 that passes control of a processor 2004 between different tasks, whereby each task returns control of the one or more processors 2004 to the timesharing program 2020 upon completion of any outstanding operations and/or in response to an input such as an interrupt. When a task has control of the one or more processors 2004, the processing circuit is effectively specialized for the purposes addressed by the function associated with the controlling task. The timesharing program 2020 may include an operating system, a main loop that transfers control on a round-robin basis, a function that allocates control of the one or more processors 2004 in accordance with a prioritization of the functions, and/or an interrupt driven main loop that responds to external events by providing control of the one or more processors 2004 to a handling function.

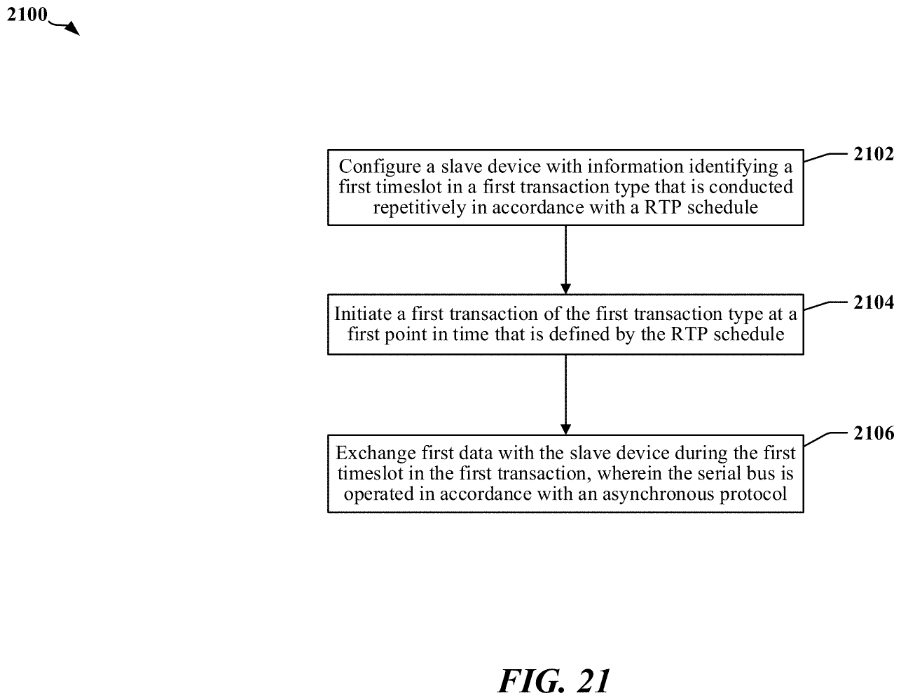

FIG. 21 is a flowchart 2100 illustrating a process that may be performed at a master device coupled to a serial bus. The serial bus may be operated in accordance with one or more I3C protocols. The process may relate to an arbitration process used to access to a serial bus. At block 2102, the master device may configure a slave device with information identifying a first timeslot in a first transaction type that is conducted repetitively in accordance with an RTP schedule. At block 2104, the master device may initiate a first transaction of the first transaction type at a first point in time that is defined by the RTP schedule. At block 2106, the master device may exchange first data with the slave device during the first timeslot in the first transaction. The serial bus may be operated in accordance with an asynchronous protocol, such as an I3C protocol, an RFFE protocol or an SPMI protocol.

The master device may receive one or more bytes of data from the serial bus during the first timeslot in the first transaction while exchanging the first data with the slave device. The master device may transmit one or more bytes of data over the serial bus during the first timeslot in the first transaction while exchanging the first data with the slave device.

In some examples, the master device may initiate a second transaction of the first transaction type in response to an in-band interrupt asserted by the slave device. Information provided by the slave device during processing of the in-band interrupt may identify the first transaction type. The second transaction may be conducted independently of the RTP schedule.

In one example, the master device may initiate a second transaction of the first transaction type independently of the RTP schedule. In one example, the master device may transmit timing configuration information to the slave device. The timing configuration information may identify periodicity of the first timeslot in the first transaction type.

In certain examples, the master device may configure the slave device with information identifying a second timeslot in a first transaction type, and exchange second data with the slave device during the second timeslot in the first transaction.

In some examples, the master device may configure the slave device with information identifying a second timeslot in a second transaction type that is conducted repetitively in accordance with the RTP schedule, initiate a first transaction of the second transaction type at a second point in time that is defined by the RTP schedule, and exchange one or more bytes of data with the slave device during the second timeslot in the second transaction. A first broadcast command code may be transmitted at the first point in time to initiate the first transaction of the first transaction type, and a second broadcast command code may be transmitted at the second point in time to initiate the first transaction of the second transaction type. The periodicity of transactions of the first transaction type may be the same or different from the periodicity of transactions of the second transaction type.

In one example, the master device may broadcast a stop command identifying the first transaction type, where the stop command cancels one or more scheduled transmissions of the first transaction type.

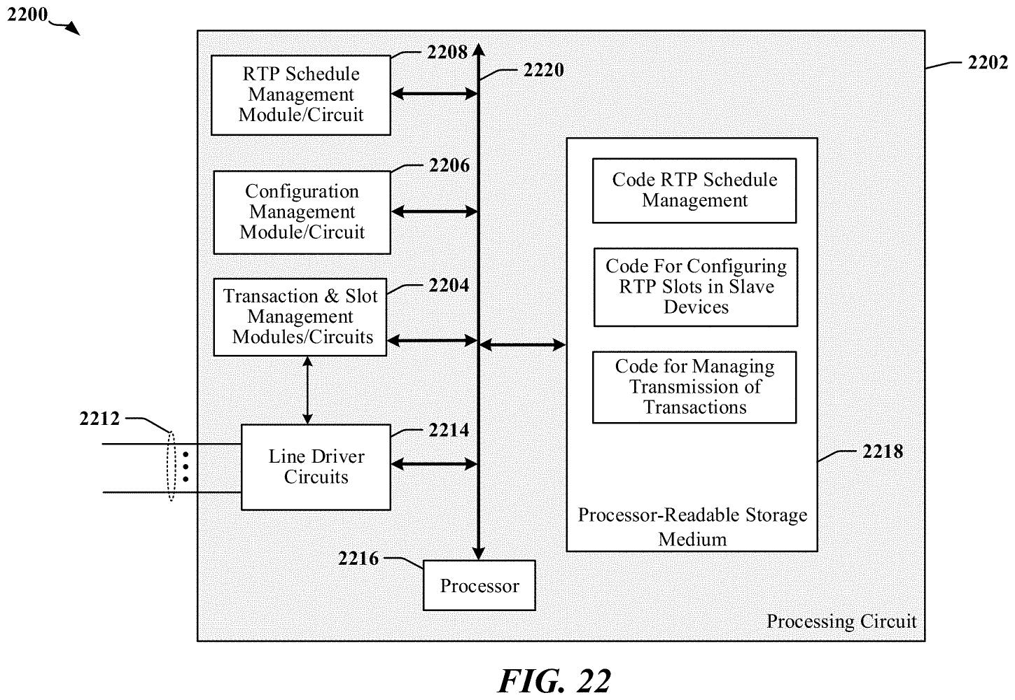

FIG. 22 is a diagram illustrating an example of a hardware implementation for an apparatus 2200 employing a processing circuit 2202. In one example, the apparatus 2200 is configured for data communication over a serial bus that is operated in accordance with one or more I3C protocols. The processing circuit typically has a controller or processor 2216 that may include one or more microprocessors, microcontrollers, digital signal processors, sequencers and/or state machines. The processing circuit 2202 may be implemented with a bus architecture, represented generally by the bus 2220. The bus 2220 may include any number of interconnecting buses and bridges depending on the specific application of the processing circuit 2202 and the overall design constraints. The bus 2220 links together various circuits including one or more processors and/or hardware modules, represented by the controller or processor 2216, the modules or circuits 2204, 2206 and 2208, and the processor-readable storage medium 2218. The apparatus may be coupled to a multi-wire communication link using a physical layer circuit 2214. The physical layer circuit 2214 may operate the multi-wire serial bus 2212 to support communications in accordance with I3C protocols. The bus 2220 may also link various other circuits such as timing sources, peripherals, voltage regulators, and power management circuits, which are well known in the art, and therefore, will not be described any further.

The processor 2216 is responsible for general processing, including the execution of software, code and/or instructions stored on the processor-readable storage medium 2218. The processor-readable storage medium 2218 may include non-transitory storage media. The software, when executed by the processor 2216, causes the processing circuit 2202 to perform the various functions described supra for any particular apparatus. The processor-readable storage medium 2218 may be used for storing data that is manipulated by the processor 2216 when executing software. The processing circuit 2202 further includes at least one of the modules 2204, 2206 and 2208. The modules 2204, 2206 and 2208 may be software modules running in the processor 2216, resident/stored in the processor-readable storage medium 2218, one or more hardware modules coupled to the processor 2216, or some combination thereof. The modules 2204, 2206 and 2208 may include microcontroller instructions, state machine configuration parameters, or some combination thereof.

In one configuration, the apparatus 2200 includes physical layer circuit 2214 that may include one or more line driver circuits including a first line driver coupled to a first wire of a multi-wire serial bus and a second line driver coupled to a second wire of the multi-wire serial bus 2212. The apparatus 2200 includes modules and/or circuits 2208 configured to manage or implement an RTP schedule, modules and/or circuits 2206 configured to provide RTP configuration of one or more slave devices, and modules and/or circuits 2204 configured to manage transactions and/or timeslots within transaction conducted on the serial bus.

In one example, the apparatus 2200 includes a processor 2216 configured to configure a slave device with information identifying a first timeslot in a first transaction type that is conducted repetitively in accordance with a RTP schedule, initiate a first transaction of the first transaction type at a first point in time that is defined by the RTP schedule, and exchange first data with the slave device during the first timeslot in the first transaction. The serial bus may be operated in accordance with an asynchronous protocol, such as an I3C, RFFE or SPMI protocol.

The processor 2216 may be further configured to receive one or more bytes of data from the serial bus during the first timeslot in the first transaction. The processor 2216 may be further configured to transmit one or more bytes of data over the serial bus during the first timeslot in the first transaction. The processor 2216 may be further configured to initiate a second transaction of the first transaction type in response to an in-band interrupt asserted by the slave device. Information provided by the slave device during processing of the in-band interrupt may identify the first transaction type. The second transaction may be conducted independently of the RTP schedule. The processor 2216 may be further configured to initiate the second transaction of the first transaction type independently of the RTP schedule.

The processor 2216 may be further configured to configure the slave device with information identifying a second timeslot in a first transaction type, and exchange second data with the slave device during the second timeslot in the first transaction.

The processor 2216 may be adapted to configure the slave device with information identifying a second timeslot in a second transaction type that is conducted repetitively in accordance with the RTP schedule, initiate a first transaction of the second transaction type at a second point in time that is defined by the RTP schedule, and exchange one or more bytes of data with the slave device during the second timeslot in the second transaction. A first broadcast command code may be transmitted at the first point in time to initiate the first transaction of the first transaction type, and a second broadcast command code may be transmitted at the second point in time to initiate the first transaction of the second transaction type. The periodicity of transactions of the first transaction type may be the same or different from the periodicity of transactions of the second transaction type.

In one example, the processor 2216 may be further configured to broadcast a stop command identifying the first transaction type, where the stop command cancels one or more scheduled transmissions of the first transaction type. In one example, the processor 2216 may be further configured to transmit timing configuration information to the slave device. The timing configuration information may identify periodicity of the first timeslot in the first transaction type.

The processor-readable storage medium 2218 may include instructions that cause the processing circuit 2202 to configure a slave device with information identifying a first timeslot in a first transaction type that is conducted repetitively in accordance with a RTP schedule, initiate a first transaction of the first transaction type over the serial bus at a first point in time that is defined by the RTP schedule, and exchange first data with the slave device during the first timeslot in the first transaction. The serial bus may be operated in accordance with an asynchronous protocol. The asynchronous protocol may be an I3C protocol.

In some implementations, the first data is exchanged with the slave device by receiving one or more bytes of data from the serial bus during the first timeslot in the first transaction. The first data may be exchanged with the slave device by transmitting one or more bytes of data over the serial bus during the first timeslot in the first transaction.

The processor-readable storage medium 2218 may include instructions that cause the processing circuit 2202 to initiate a second transaction of the first transaction type in response to an in-band interrupt asserted by the slave device. Information provided by the slave device during processing of the in-band interrupt may identify the first transaction type. The second transaction may be conducted independently of the RTP schedule. The processor-readable storage medium 2218 may include instructions that cause the processing circuit 2202 to initiate a second transaction of the first transaction type independently of the RTP schedule.

The processor-readable storage medium 2218 may include instructions that cause the processing circuit 2202 to configure the slave device with information identifying a second timeslot in the first transaction type, and exchange second data with the slave device during the second timeslot in the first transaction.

The processor-readable storage medium 2218 may include instructions that cause the processing circuit 2202 to configure the slave device with information identifying a second timeslot in a second transaction type that is conducted repetitively in accordance with the RTP schedule, initiate a second transaction of the second transaction type at a second point in time that is defined by the RTP schedule, and exchange one or more bytes of data with the slave device during the second timeslot in the second transaction. Some instructions may cause the processing circuit 2202 to transmit a first broadcast command code at the first point in time to initiate the first transaction of the first transaction type, and transmit a second broadcast command code at the second point in time to initiate the second transaction of the second transaction type. Periodicity of transactions of the first transaction type may be different from the periodicity of transactions of the second transaction type.

The processor-readable storage medium 2218 may include instructions that cause the processing circuit 2202 to broadcast a stop command identifying the first transaction type. The stop command may be broadcast to cancel one or more scheduled transmissions of the first transaction type. The processor-readable storage medium 2218 may include instructions that cause the processing circuit 2202 to transmit timing configuration information to the slave device. The timing configuration information may identify periodicity of the first timeslot in the first transaction type.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for managing transactions executed on a serial bus, comprising:
configuring a slave device with information identifying a first timeslot in a first transaction type that is conducted repetitively in accordance with a repetitive time period (RTP) schedule;
initiating a first transaction of the first transaction type over the serial bus at a first point in time that is defined by the RTP schedule; and
exchanging first data with the slave device during the first timeslot in the first transaction,
wherein the serial bus is operated in accordance with an asynchronous protocol.

2. The method of claim 1, wherein the asynchronous protocol comprises an I3C protocol.

3. The method of claim 1, wherein exchanging the first data with the slave device comprises:
receiving one or more bytes of data from the serial bus during the first timeslot in the first transaction.

4. The method of claim 1, wherein exchanging the first data with the slave device comprises:
transmitting one or more bytes of data over the serial bus during the first timeslot in the first transaction.

5. The method of claim 1, further comprising:
initiating a second transaction of the first transaction type in response to an in-band interrupt asserted by the slave device, wherein information provided by the slave device during processing of the in-band interrupt identifies the first transaction type, and wherein the second transaction is conducted independently of the RTP schedule.

6. The method of claim 1, further comprising:
transmitting timing configuration information to the slave device,
wherein the timing configuration information identifies periodicity of the first timeslot in the first transaction type.

7. The method of claim 1, further comprising:
configuring the slave device with information identifying a second timeslot in the first transaction type; and
exchanging second data with the slave device during the second timeslot in the first transaction.

8. The method of claim 1, further comprising:
configuring the slave device with information identifying a second timeslot in a second transaction type that is conducted repetitively in accordance with the RTP schedule;
initiating a second transaction of the second transaction type at a second point in time that is defined by the RTP schedule; and
exchanging one or more bytes of data with the slave device during the second timeslot in the second transaction.

9. The method of claim 8, further comprising:
transmitting a first broadcast command code at the first point in time to initiate the first transaction of the first transaction type; and
transmitting a second broadcast command code at the second point in time to initiate the second transaction of the second transaction type.

10. The method of claim 8, wherein periodicity of transactions of the first transaction type is different from periodicity of transactions of the second transaction type.

11. The method of claim 1, further comprising:
broadcasting a stop command identifying the first transaction type, wherein the stop command cancels one or more scheduled transmissions of the first transaction type.

12. An apparatus configured for data communication, comprising:
a bus interface configured to couple the apparatus to a serial bus having a first line configured to carry a clock signal and a second line configured to carry a first data signal; and
a processor configured to:
configure a slave device with information identifying a first timeslot in a first transaction type that is conducted repetitively in accordance with a repetitive time period (RTP) schedule;
initiate a first transaction of the first transaction type over the serial bus at a first point in time that is defined by the RTP schedule; and
exchange first data with the slave device during the first timeslot in the first transaction,
wherein the serial bus is operated in accordance with an asynchronous protocol.

13. The apparatus of claim 12, wherein the asynchronous protocol comprises an I3C protocol.

14. The apparatus of claim 12, wherein the processor is further configured to:
receive one or more bytes of data from the serial bus during the first timeslot in the first transaction.

15. The apparatus of claim 12, wherein the processor is further configured to:
initiate a second transaction of the first transaction type in response to an in-band interrupt asserted by the slave device, wherein information provided by the slave device during processing of the in-band interrupt identifies the first transaction type, and wherein the second transaction is conducted independently of the RTP schedule.

16. The apparatus of claim 12, wherein the processor is further configured to:
cause timing configuration information to be transmitted to the slave device,
wherein the timing configuration information identifies periodicity of the first timeslot in the first transaction type.

17. The apparatus of claim 12, wherein the processor is further configured to:
configure the slave device with information identifying a second timeslot in the first transaction type; and
exchange second data with the slave device during the second timeslot in the first transaction.

18. The apparatus of claim 12, wherein the processor is further configured to:
configure the slave device with information identifying a second timeslot in a second transaction type that is conducted repetitively in accordance with the RTP schedule;
initiate a second transaction of the second transaction type at a second point in time that is defined by the RTP schedule; and
exchange one or more bytes of data with the slave device during the second timeslot in the second transaction.

19. The apparatus of claim 18, wherein the processor is further configured to:
transmit a first broadcast command code at the first point in time to initiate the first transaction of the first transaction type; and
transmit a second broadcast command code at the second point in time to initiate the second transaction of the second transaction type.

20. The apparatus of claim 18, wherein periodicity of transactions of the first transaction type is different from periodicity of transactions of the second transaction type.

21. The apparatus of claim 12, wherein the processor is further configured to:
broadcast a stop command identifying the first transaction type, and wherein the stop command cancels one or more scheduled transmissions of the first transaction type.

22. A processor-readable storage medium including code which, when executed by a processor, causes the processor to:
configure a slave device with information identifying a first timeslot in a first transaction type that is conducted repetitively in accordance with a repetitive time period (RTP) schedule over a serial bus;
initiate a first transaction of the first transaction type at a first point in time that is defined by the RTP schedule; and
exchange first data with the slave device during the first timeslot in the first transaction,
wherein the serial bus is operated in accordance with an asynchronous protocol.

23. The storage medium of claim 22, further comprising code that causes the processor to:
receive one or more bytes of data from the serial bus during the first timeslot in the first transaction.

24. The storage medium of claim 22, further comprising code that causes the processor to:
initiate a second transaction of the first transaction type in response to an in-band interrupt asserted by the slave device, wherein information provided by the slave device during processing of the in-band interrupt identifies the first transaction type, and wherein the second transaction is conducted independently of the RTP schedule.

25. The storage medium of claim 22, further comprising code that causes the processor to:
transmit timing configuration information to the slave device, wherein the timing configuration information identifies periodicity of the first timeslot in the first transaction type.

26. The storage medium of claim 22, further comprising code that causes the processor to:
configure the slave device with information identifying a second timeslot in the first transaction type; and
exchange second data with the slave device during the second timeslot in the first transaction.

27. The storage medium of claim 22, further comprising code that causes the processor to:
configure the slave device with information identifying a second timeslot in a second transaction type that is conducted repetitively in accordance with the RTP schedule;
initiate a second transaction of the second transaction type at a second point in time that is defined by the RTP schedule; and
exchange one or more bytes of data with the slave device during the second timeslot in the second transaction.

28. The storage medium of claim 27, further comprising code that causes the processor to:
transmit a first broadcast command code at the first point in time to initiate the first transaction of the first transaction type; and
transmit a second broadcast command code at the second point in time to initiate the second transaction of the second transaction type,
wherein periodicity of transactions of the first transaction type is different from periodicity of transactions of the second transaction type.

29. The storage medium of claim 22, further comprising code that causes the processor to:
broadcast a stop command identifying the first transaction type, wherein the stop command cancels one or more scheduled transmissions of the first transaction type.

30. An apparatus configured for data communication, comprising:
means for configuring a slave device with information identifying a first timeslot in a first transaction type that is conducted repetitively in accordance with a repetitive time period (RTP) schedule;
means for initiating a first transaction of the first transaction type over a serial bus at a first point in time that is defined by the RTP schedule; and
means for exchanging first data with the slave device during the first timeslot in the first transaction,
wherein the serial bus is operated in accordance with an I3C protocol.
